(19) United States
(12) Patent Application Publication
(10) Pub. No.: US 2025/0143282 A1
(43) Pub. Date: May 8, 2025

(54) Configurable Dual Boom Nozzle with Orifice Control

(71) Applicant: Raven Industries, Inc., Sioux Falls, SD (US)

(72) Inventors: Jared Ernest Kocer, Sioux Falls, SD (US); John D. Preheim, Beresford, SD (US)

(21) Appl. No.: 18/938,530

(22) Filed: Nov. 6, 2024

Related U.S. Application Data
(60) Provisional application No. 63/596,546, filed on Nov. 6, 2023.
(60) Provisional application No. 63/596,914, filed on Nov. 7, 2023.

(51) Int. Cl. A01M 7/00; A01C 23/04; B05B 7/24; B05B 7/28

(52) U.S. Cl. CPC A01M 7/0089; A01C 23/047; A01M 7/006; B05B 7/2486; B05B 7/28

(57) ABSTRACT

A configurable nozzle system includes, for example, a first nozzle with a first nozzle and a second nozzle. Optionally, a nozzle housing retains both the first nozzle and the second nozzle. The nozzle housing includes, for example plumbing that interconnects the nozzle passages. In an example, a bridging valve coupled along the nozzle manifold selectively interconnects the nozzle passages, regulating agricultural fluid flow between them. Optionally, one of the first nozzle or second nozzle includes a configurable nozzle assembly and the other of the first nozzle or second nozzle includes a standard tip nozzle. The standard tip nozzle, for example, is in communication with a responsive flow control system.

### PRIORITY APPLICATIONS

This application claims the benefit of priority to U.S. Provisional Application Ser. No. 63/596,546, filed Nov. 6, 2023 and U.S. Provisional Application Ser. No. 63/596,914, filed Nov. 7, 2023, the contents of which are incorporated herein by reference in their entireties.

### BACKGROUND

Agricultural sprayers include vehicles and vehicle-drawn implements that conduct spraying operations. Agricultural sprayers are used to spray agricultural products, such as fertilizers, insecticides, herbicides and fungicides to crops in an agricultural field. Agricultural fields are, in some examples, irregular in shape and contain one or more of contour changes, tree lines, hillsides, ponds or streams. Agricultural sprayers include one or more distribution booms with nozzles that spray multiple rows of crops in a single pass. The agricultural sprayer, in some examples, sprays agricultural fluid to the agricultural field in having rows of crops planted along an irregular path (e.g., contour changes, divergence around obstacles, etc.).

Agricultural sprayers include a reservoir for a carrier fluid (e.g., product or substance). The reservoir is in communication, by way of a header tube or pipe, with a plurality of sections provided along one or more carrier booms (e.g., boom tubes). The header is the main line extending between the reservoir and the carrier booms. Each of the plurality of sections includes one or more sprayer nozzle assemblies that distributes the carrier fluid received by the section. In some examples, the carrier fluid is used as a vehicle to carry and distribute one or more injection products dispersed into the carrier substance, for instance herbicides, pesticides, fertilizers or the like, the carrier fluid and injection product referred to collectively as the agricultural product.

In one example, a reservoir retains the injection product separate from the reservoir for the carrier fluid. The injection product is, in some instances, pumped from the reservoir and delivered from the reservoir to the header of the carrier substance. In some examples, an inline mixer (e.g., a static mixer) mixes the injected chemical with the carrier substance upstream from or within the header. The header then delivers the mixture to the boom tubes, and the mixture is distributed to the sections and the nozzle assemblies associated with each of the sections.

In an example, the nozzle assemblies are adjusted by operators based on operator knowledge of the target crop, pests or weeds present in the field, understanding of crop health within a field, present weather conditions (e.g., wind speed and direction, precipitation, temperature or the like), characteristics of the agricultural product (optionally the injection product(s)), manufacturer specified prescriptions for the application of the agricultural product or the like. The nozzle assemblies are in various examples adjusted by the operator (e.g., manually changed out or manually adjusted) to control one or more nozzle characteristics including droplet size, spray pattern (e.g., arc, arc orientation or the like).

### Overview

Agricultural vehicles sometimes include components used to dispense liquids, particulates, or other products onto a field. In some examples, the dispensed products are sprayed onto a field with an agricultural sprayer. Agricultural sprayers include a fluid dispense system including at least one boom tube for dispensing an agricultural product (e.g., carrier fluid, fertilizers, insecticides, herbicides and fungicides, a mixture of fluids, or the like) from a central location toward a system of nozzles.

In examples described herein, the system of nozzles includes a configurable nozzle system that is, for example, coupled to a boom tube of a sprayer, or other agricultural vehicle. The configurable nozzle system includes, for example, a nozzle housing that retains at least a first nozzle and a second nozzle. The nozzle housing, in some instances, also includes plumbing coupling or connecting the first nozzle with the second nozzle, such as a manifold. In another example, the nozzle housing houses plumbing that connects a first boom tube with one of the first nozzle or the second nozzle and plumbing that connects a second boom tube with the other of the first nozzle or the second nozzle.

In an example, the first nozzle includes a first nozzle passage and a first nozzle spray orifice in communication with the first nozzle passage. The first nozzle spray orifice sprays a carrier fluid, in one example, toward the field. In another example, the second nozzle includes a second nozzle passage and a second nozzle spray orifice in communication with the second nozzle passage. The second nozzle spray orifice sprays, an agricultural product, in another example, toward the field. Optionally, one or more of the first nozzle or the second nozzle dispenses both a carrier fluid and an agricultural product (collectively referred to in some places herein as an agricultural product), individually or as a mixture.

In one example, the plumbing housed within the nozzle housing includes one or more valves. The one or more valves interconnect (e.g., couples, fluidly connect) the first nozzle passage with the second nozzle passage. Optionally, the one or more valves selectively interconnect the first nozzle passage and the second nozzle passage. Selectively interconnecting (as discussed herein) includes, for instance, opening a passage between the first nozzle passage and the second nozzle passage to allow product flowing toward one of the first nozzle or the second nozzle to change direction to flow toward the other of the first nozzle or the second nozzle (or to both). In one example, the valve is a bridging valve that regulates the product flowing between the first nozzle passage and the second nozzle passage.

### BRIEF DESCRIPTION OF THE DRAWINGS

FIG. 1 illustrates an example of an agricultural vehicle, such as a spraying including a plumbing system for a configurable nozzle system according to at least one example of the present disclosure.

FIG. 2 illustrates a plumbing system for a configurable nozzle system according to at least one example of the present disclosure.

FIG. 3A illustrates is an example of a configurable nozzle system according to at least one example of the present disclosure.

FIG. 3B illustrates a schematic of the configurable nozzle system according to at least one example of the present disclosure.

FIG. 4A illustrates an example of a configurable nozzle system according to at least one example of the present disclosure.

FIG. 4B illustrates a schematic of a configurable nozzle system according to at least one example of the present disclosure.

FIG. 5A illustrates an example of a configurable nozzle system according to at least one example of the present disclosure.

FIG. 5B illustrates a schematic of a configurable nozzle system according to at least one example of the present disclosure.

FIG. 5C illustrates a schematic of a configurable nozzle system according to at least one example of the present disclosure.

FIG. 6A illustrates an example of a configurable nozzle system according to at least one example of the present disclosure.

FIG. 6B illustrates a schematic of a configurable nozzle system according to at least one example of the present disclosure.

FIG. 7A illustrates an example of a configurable nozzle system according to at least one example of the present disclosure.

FIG. 7B illustrates a schematic of a configurable nozzle system according to at least one example of the present disclosure.

FIG. 8 illustrates an example configurable nozzle assembly according to at least one example of the present disclosure.

FIG. 9 illustrates an example plumbing system for a configurable nozzle system according to at least one example of the present disclosure.

FIG. 10 illustrates an example plumbing system for a configurable nozzle system according to at least one example of the present disclosure.

FIG. 11 illustrates an example plumbing system for a configurable nozzle system according to at least one example of the present disclosure.

FIG. 12 illustrates an example plumbing system for a configurable nozzle system according to at least one example of the present disclosure.

FIG. 13 illustrates an example method of distributing fluid from the configurable nozzle system according to at least one example of the present disclosure.

### DETAILED DESCRIPTION

In agricultural operations, systems, components, tools or vehicles are used individually or in combination for conducting agricultural operations in a field. For example, agricultural operations include, but are not limited to, spraying, spreading, harvesting, gathering, planting, mowing, cutting, tilling, cultivating, baling or the like. In some examples, sprayers prepare or treat a field or crops in a field. Sprayers are agricultural vehicles, or separate implements coupled with a tractor or the like, that include one or more sprayer booms extending from the vehicle or pulled implement. The sprayer booms include plumbing and a plurality of spray nozzles for application of agricultural products in a field, for instance to the soil, crops, pests, weeds or the like.

The one or more sprayer booms optionally includes one or more boom sections, such as proximate, distal and central sections. In some examples, one or more sprayer booms that includes plumbing extending along the one or more sections. The one or more sprayer booms transfers agricultural fluid (e.g., water, carrier fluid, mixtures of water and carrier fluid, or the like) from a fluid source (e.g., reservoir, tank, container, cartridge, or the like) to at least one nozzle assembly (a fluid dispense mechanism). In an example, the at least one nozzle assembly is provided along the sprayer booms or sprayer boom sections and the nozzle assembly is in communication with the reservoir via intervening pumps, tubing or the like. Each nozzle assembly has an orifice, or opening, that dispenses or distributes, as a spray, the agricultural fluid transferred from the reservoir out to targets (e.g., crop, portions of crops such as foliage, weeds, pests, soil or the like). For example, each nozzle assembly sprays agricultural fluid particles (e.g., droplets) having a specified size (including range of sizes) in a specified spray pattern towards targets. The sprayer also includes at least one fluid source (e.g., reservoir, tank, container, cartridge, or the like) as a central location that contains an agricultural product including, but not limited to, a carrier fluid, such as water or an agricultural fluid (e.g., herbicides, fungicides, pesticides, insecticides, fertilizers or the like). In some examples, the sprayer supports two fluid sources, for instance a fluid source for a carrier fluid (e.g., water or a premixed agricultural fluid) and a second fluid source for the agricultural fluid. In other examples, the sprayer includes multiple fluid sources each fluid source containing one of a carrier fluid, an agricultural fluid or a premixed agricultural fluid.

In an example with two or more fluid sources, the carrier fluid is transported through a first boom tube to one or more first nozzles. A second fluid, either carrier fluid or agricultural fluid, is transported through a second boom tube to one or more second nozzles. Optionally, the carrier fluid is mixed with the agricultural fluid at a location remote from the nozzles. The mixed agricultural product is sprayed from each of the one or more nozzles. The sprayed mixture is, for example, the same or similar mixture from each of the one or more nozzles. In some situations, an agricultural target (e.g., crop, pest, weed or the like) receiving the sprayed agricultural product (e.g., carrier fluid, agricultural fluid, or a mixture) does not require or benefit from the sprayed agricultural product. For example, the one or more nozzles is, for example, a component of the nozzle system, as described further below, that operate jointly and distribute the same or a similar agricultural products as adjacent nozzles.

An agricultural vehicle, such as a sprayer, that includes one or more nozzles that, for example, sprays the same or similar fluid as adjacent nozzles presents a challenge when the sprayed agricultural product does not require or benefit from the sprayed agricultural product. In another example, having one option for an agricultural product (e.g., carrier fluid, water, agricultural fluid) causes inefficiencies when spraying a field. In some examples, the user needs to stop spraying to change the agricultural product. Changing the agricultural product, in some instances, results in an increased amount of time to spray the agricultural targets.

In an example, the present subject matter provides a solution to these problems, such as by providing a configurable nozzle system on a sprayer. The configurable nozzle system, for example, is customizable to the specific agricultural target. In an example, the configurable nozzle system rapidly changes the sprayed agricultural product as the sprayer travels through a field according to the specific agricultural targets.

For instance, the configurable nozzle system includes at least two boom tubes coupled and fluidly connected by one or more flow paths with a configurable nozzle assembly. Each of the boom tubes is coupled with a fluid source, such as a carrier fluid source or an agricultural fluid source, collectively referred to as agricultural products. In an example, a third or fourth fluid source is fluidly connected with one or both of the first boom tube or the second boom tube. For instance, a third or fourth fluid source is coupled with one or both of the first boom tube or the second boom tube. The fluid from the first or second boom tube is mixed with the fluid from the third or fourth fluid source proximate to the nozzle assembly before application. For example, the third fluid source and the fourth fluid source are positioned along a flow path extending from one of the carrier fluid source or the agricultural fluid source. Optionally, the third fluid and the fourth fluid, either individually or together, are injected or supplied into the flow path extending from the carrier fluid or the agricultural fluid. Optionally, additional fluid sources are fluidly connected with one or both of the flow paths extending from the carrier fluid or the agricultural fluid to a respective nozzle assembly. In one example, the fluid from the third or fourth fluid source is mixed with the fluid from the first or second fluid source at a location upstream from the nozzle assembly and transported after mixing to the nozzle.

The configurable nozzle system includes one or more couplings, to couple (e.g., retain, hold) at least a first boom tube and a second boom tube with a nozzle housing (discussed further below). The configurable nozzle system interconnects the two boom tubes proximate or at a nozzle housing. The nozzle housing houses (e.g., retains, contains, holds or the like) a nozzle assembly. The nozzle assembly includes, for example, a manifold including plumping for dispensing the agricultural product along one or more flow paths. The one or more flow paths optionally includes one or more metering mechanisms (e.g., valves, throttling elements, pumps or the like) for selective application and fluid communication at the one or more nozzle.

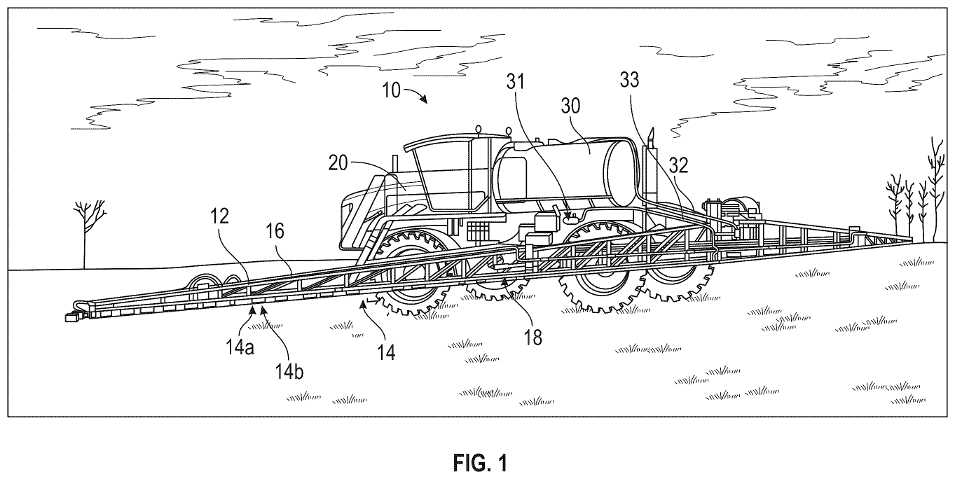

An agricultural sprayer system 10 is illustrated in FIG. 1. The agricultural sprayer system 10 includes an agricultural vehicle 20 having a boom 12. The boom 12 includes, for example, one or more boom tubes such as a first boom tube 16 and a second boom tube 18. The first boom tube 16 and the second boom tube 18 are each supported and extend along the boom 12. Optionally, the first boom tube 16 and the second boom tube 18 are fluidly connected with plumbing with a first fluid source 30 and a second fluid source 31. For example, a first plumbing system 32 is fluidly connected between the first fluid source 30 and the first boom tube 16 and a second plumbing system 33 fluidly connects the second fluid source 31 and the second boom tube 18. The first fluid source 30 contains (e.g., retain, hold or the like), for instance, a carrier fluid such as water or a premixed fluid including water and an additive. The second fluid source 31 contains (e.g., retain, hold or the like) an agricultural fluid (e.g., herbicides, fungicides, pesticides, insecticides, fertilizers or the like).

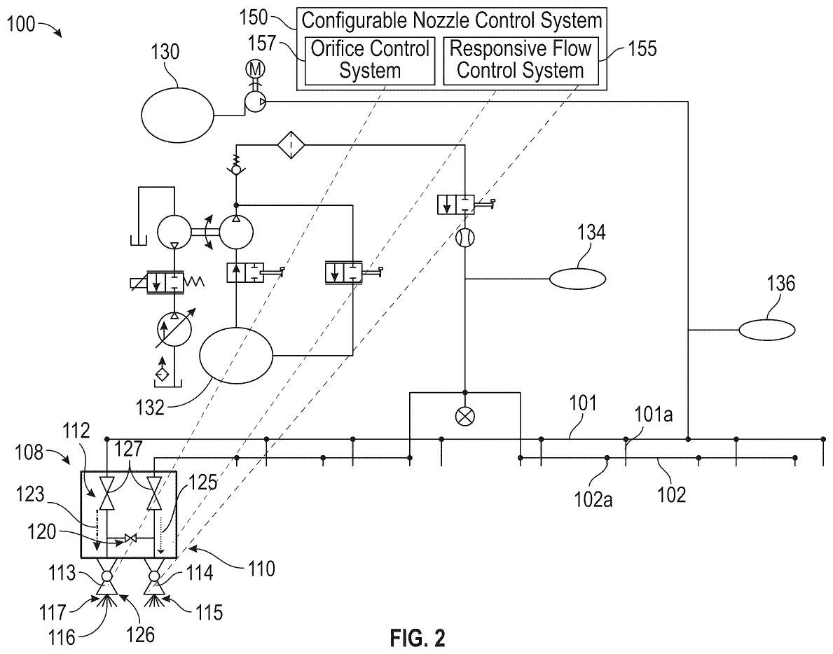

Positioned along at least a portion of one or more of the first boom tube 16 and the second boom tube 18 are one or more nozzle assemblies 14. Optionally, the one or more nozzle assemblies 14 is positioned and spaced along the one of the first boom tube 16 or the second boom tube 18 according to a specified purpose. The one or more nozzle assemblies 14 is oriented to spray an agricultural fluid or a carrier fluid towards the field. The one or more nozzle assemblies 14 is fluidly connected with one of the first fluid source 30 or the second fluid source 31. For instance, the one or more nozzle assemblies 14 includes a first nozzle assembly 14a and a second nozzle assembly 14b discussed further related to FIGS. 2 to 12. Optionally, the first nozzle assembly 14a and the second nozzle assembly 14b are fluidly connected with the first fluid source 30 and the second fluid source 31, respectively.

In an example, the first nozzle assembly 14a and the second nozzle assembly 14b are fluidly connected in a configurable arrangement. For example, the fluid flowing towards the first nozzle assembly 14a or the second nozzle assembly 14b is controlled (e.g., selected, determined, regulated or the like) based on the specified purpose. For instance, a user controls the fluid flowing towards the first nozzle assembly 14a or the second nozzle assembly 14b according to a specified purpose. In an example, the fluid flows towards the one or more nozzle assemblies 14 through a system of internal plumbing (as described in more detail below) having components that permits the fluid from one of the first fluid source 30 or the second fluid source 31 to flow to the desired nozzle of the one or more nozzle assemblies 14.

Illustrated in FIG. 2 is an example of a configurable nozzle system 100. The configurable nozzle system 100 includes a first fluid source 130 and a second fluid source 132. The first fluid source 130 and the second fluid source 132 are coupled with at least a portion of an agricultural vehicle, such as agricultural sprayer system 10 of FIG. 1. The first fluid source 130 contains (e.g., retains, holds or the like) an agricultural product such as a carrier fluid (e.g., water or a premixed agricultural fluid). The second fluid source 132 contains (e.g., retains, holds or the like) an agricultural product such as an agricultural fluid (e.g., herbicides, fungicides, pesticides, insecticides, fertilizers, concentrates, mixes of the same, or the like). Optionally, the first fluid source 130 and the second fluid source 132 each contain the same fluid.

The agricultural vehicle, such as agricultural sprayer system 10 of FIG. 1, includes one or more booms, such as boom 12 in FIG. 1. In an example, a first boom tube 101 and a second boom tube 102 are each coupled with the boom, such as boom 12. In examples, the first boom tube 101 and the second boom tube 102 are separate fluid pathways formed with a partition extending along a single boom tube. The boom tube including one or more partitions is similar to the boom tube discussed in U.S. application Ser. No. 16/476,016, filed Jan. 5, 2018, titled “Localized Product Injection System and Methods for the Same” incorporated herein in its entirety. In an example, the first boom tube 101 and the second boom tube 102 are separate tubes extending along the boom 12. In another example, the first boom tube 101 includes a one or more first fluid connections 101a and the second boom tube 102 includes one or more second fluid connections 102a. The one or more first fluid connection 101a and the one or more second fluid connection 102a are, for example, connected with a nozzle housing 108. While not illustrated, optionally, at the end of each of the one or more first fluid connections 101a and the one or more second fluid connections 102a is the nozzle housing 108.

The first boom tube 101 is fluidly connected with, for instance, the first fluid source 130 and the second boom tube 102 is fluidly connected with, for instance, the second fluid source 132. In some examples, a first fluid, such as a carrier fluid (an example agricultural product), is supplied from the first fluid source 130 into and along the first boom tube 101. In another example, a second fluid, such as an agricultural fluid (another example agricultural product), is supplied from the second fluid source 132 into and along the second boom tube 102. In some examples, the first fluid and the second fluid are mixed according to a specified concentration ratio of the first fluid to the second fluid, or a ratio of the second fluid to the first fluid (a further example of agricultural product). In one example, mixing of the first fluid and the second fluid occurs before entering one or both of the boom tubes, such as before entering the first boom tube 101 or the second boom tube 102. In other examples, mixing occurs after delivery from the first fluid source 130 and the second fluid source 132, along the respective first boom tube 101 and second boom tube 102. For instance, mixing is conducted proximate to (e.g., within, immediately before, or the like) a configurable nozzle assembly 110.

In an example, the first boom tube 101 fluidly interconnects the first fluid source 130 with the configurable nozzle assembly 110. The configurable nozzle assembly 110 is, for example, retained (e.g., housed, contained, held or the like) within a nozzle housing 108. In one example, the first boom tube 101 and the second boom tube 102 are each coupled with the nozzle housing 108. In one example, the first fluid source 130 contains the carrier fluid and the first boom tube 101 transfers the carrier fluid from the first fluid source 130 to the configurable nozzle assembly 110. In another example, the second fluid source 132 contains the agricultural fluid and the second boom tube 102 transfers the agricultural fluid from the second fluid source 132 to the configurable nozzle assembly 110.

A nozzle manifold 112, for example, interconnects a first fluid flow passage 123 with a second fluid flow passage 125. The nozzle manifold 112 is, for example, included (e.g., retained, contained, housed, held or the like) in a nozzle housing 108. The nozzle housing 108 retains at least a portion of the nozzle manifold 112. The nozzle manifold 112 includes one or more of plumbing tubes, metering elements (e.g., valves, throttling elements, pumps or the like), or the like that transfer fluid toward one or more nozzles, as described further below.

The configurable nozzle assembly 110 includes at least two nozzles, such as a first nozzle 113 and a second nozzle 114. The first and second nozzles 113, 114 are in one example components included with the nozzle housing 108. The first nozzle 113 is, for instance, fluidly connected with the first boom tube 101 and the second nozzle 114 is, for instance, fluidly connected with the second boom tube 102. In an example, the first nozzle 113 sprays the first fluid, such as carrier fluid, and the second nozzle 114 sprays the second fluid, such as agricultural fluid. Optionally, the first fluid source 130 and the second fluid source 132 contain the same fluid (e.g., an agricultural product) and the first nozzle 113 and the second nozzle 114 spray the same fluid.

In an example, the nozzle housing 108 includes the nozzle manifold 112 such as plumbing that supports the first fluid flow passage 123 and the second fluid flow passage 125. For instance, the first fluid flow passage 123 directs the carrier fluid delivered through the first boom tube 101 toward the first nozzle 113. In another example, the second fluid flow passage 125 directs the agricultural fluid delivered through the second boom tube 102 toward the second nozzle 114.

Optionally, the nozzle housing 108 includes a bridging valve 120 that interconnects the first fluid flow passage 123 and the second fluid flow passage 125. For instance, the bridging valve 120 selectively, fluidly interconnects the first fluid flow passage 123 with the second fluid flow passage 125. For example, the bridging valve 120 directs the carrier fluid from the first boom tube 101 to mix with the agricultural fluid from the second boom tube 102 in one configuration while isolating the carrier fluid and agricultural fluid in another configuration. In some examples, the bridging valve 120 directs one of the agricultural fluid or the carrier fluid to the nozzle (e.g., first nozzle 113 or second nozzle 114) that the agricultural fluid or the carrier fluid is not directly associated with (e.g., agricultural fluid is directed to the first nozzle 113 and the carrier fluid is directed to the second nozzle 114).

The bridging valve 120, in some examples, is one of a two-way valve, a three-way valve, an insert valve or the like. In a first configuration the bridging valve 120 interconnects the first fluid flow passage 123 and the second fluid flow passage 125 permitting fluid flow from one to the other. In the second configuration the bridging valve 120 is closed to interrupt the fluid flow between the first fluid flow passage 123 and the second fluid flow passage 125. The bridging valve 120, in some examples, includes a structure having one of a through port or a partition that permits or interrupts the fluid flow.

In one example, the first nozzle 113, the second nozzle 114 and the bridging valve 120 are components of the configurable nozzle assembly 110 implemented to selectively distribute the agricultural product (e.g., first fluid, second fluid or a mixture). In an example, one of the first nozzle 113 or the second nozzle 114 receives carrier fluid, and the other nozzle receives an agricultural fluid (both examples of an agricultural product). In some examples, the agricultural fluid is mixed with a second agricultural product (e.g., carrier fluid, agricultural fluid, a mixture or the like) proximate to entering the configurable nozzle assembly 110. In an example, there are different permutations of how the fluid sources are fluidly connected with the first fluid flow passage 123 or the second fluid flow passage 125. For instance, a third fluid source 134 or a fourth fluid source 136 is positioned along the fluid path between the first fluid source 130 or the second fluid source 132 and the configurable nozzle assembly 110, according to specified uses. For example, the fluid dispensed from at least one of the third fluid source 134 or the fourth fluid source 136 is supplied alone or mixed with the fluid dispensed from one of the first fluid source 130 or the second fluid source 132. Optionally, the fluid from one of the third fluid source 134 or fourth fluid source 136 is mixed before flowing through the first boom tube 101 or the second boom tube 102 (e.g., proximate to, immediately before or at the first or second boom tubes 101, 102).

In an example, a configurable nozzle control system 150 communicates with the configurable nozzle assembly 110 to control one or more metering mechanisms (e.g., valve, throttling element, pump or the like), such as the control valves 127 positioned along the first fluid flow passage 123 and the second fluid flow passage 125. In another example, the configurable nozzle control system 150 communicates with the bridging valve 120 and actuates the bridging valve 120 to transition the bridging valve 120 from the first configuration to the second configuration and direct the fluid flow between the first fluid flow passage 123 and the second fluid flow passage 125.

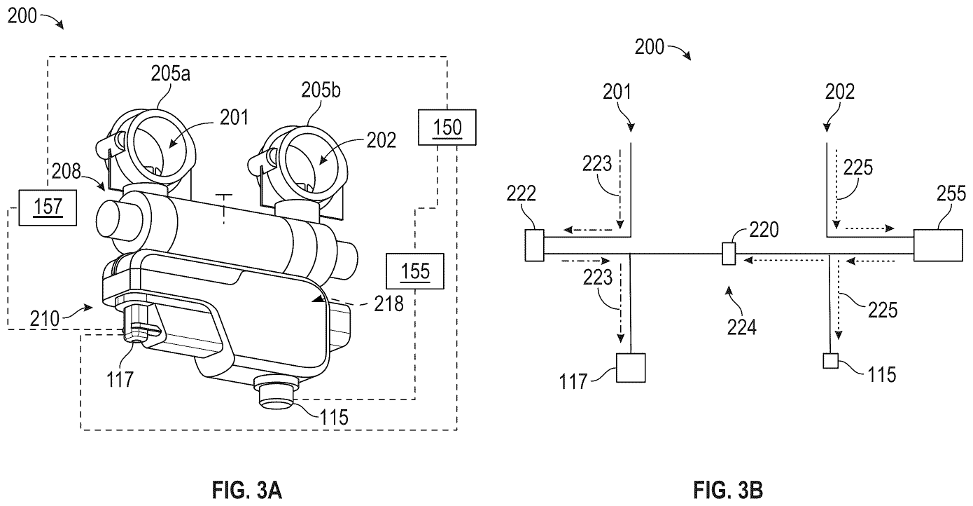

The configurable nozzle control system 150 is in communication with the configurable nozzle assembly 110. The configurable nozzle control system 150 is an example of a computer system (e.g., one or more processors) that provides one or more of communication, information storage, or the like related to one or more of supplying or dispensing fluid from the first nozzle 113 and the second nozzle 114. As discussed further below (and shown in FIGS. 3A-12), the configurable nozzle control system 150 controls the agricultural product flow through the first fluid flow passage 123 and second fluid flow passage 125 and dispensing (e.g., spraying) from the first nozzle 113 and the second nozzle 114, such as a standard tip nozzle 115 and the orifice control nozzle 117. For example, the configurable nozzle control system 150 rapidly (e.g., instantaneously, within approximately 0.5 seconds, within approximately 1.0 seconds or the like) modulates the agricultural product distributed to one or both of the first fluid flow passage 123 or the second fluid flow passage 125 or sprayed from the standard tip nozzle 115 or the orifice control nozzle 117 (examples of the first and second nozzles 113, 114). The configurable nozzle control system 150 includes one or more processors that provide communication, signals, instructions or the like within the configurable nozzle control system 150 and to the components of the configurable nozzle assembly 110 or the configurable nozzle system 100.

Optionally, the configurable nozzle control system 150 controls at least one of the bridging valves, the orifice modulating elements, two-way valves, three-way valves, or other mechanisms within the configurable nozzle assembly 110. The configurable nozzle control system 150 optionally includes, for example, an orifice control system 157 and a responsive flow control system 155. The orifice control system 157 is in communication with the orifice control nozzle 117 (e.g., having a modulating orifice element 126) and the responsive flow control system 155 is in communication with the standard tip nozzle 115. In an example, the orifice control system 157 communicates with the orifice control nozzle 117 to maintain or alter (collectively, control or modulate) the position of the modulating orifice element 126, valve or other mechanism that regulates the application of the agricultural product from the orifice control nozzle 117 (an example of the first nozzle 113). The responsive flow control system 155 is in communication with the standard tip nozzle 115 (an example of the second nozzle 114) to regulate the fluid dispensed from the standard tip nozzle 115. In an example, the responsive flow control system 155 communicates with the standard tip nozzle 115 to control one or more of the pressure or flow rate of the agricultural product supplied to the second nozzle 114 along the second fluid flow passage 125. In another example, the configurable nozzle control system 150 communicates with at least one of the bridging valves, two-way valves, three-way valves or other mechanism to control access to one or more of the orifice control nozzle 117 or the standard tip nozzle 115.

Optionally, the configurable nozzle control system 150 controls the of spray application from the standard tip nozzle 115 or the orifice control nozzle 117. For instance, the configurable nozzle control system 150 adjusts the spray of agricultural product according to locations in a field or agricultural targets encountered by the agricultural vehicle 20. For example, the configurable nozzle control system 150 communicates with mechanisms (e.g., valves, plates, throttling elements or the like) associated with the spray of agricultural product from one or more of the standard tip nozzle 115 or the orifice control nozzle 117. The communication from the configurable nozzle control system 150 adjusts one or more of a spray pattern, droplet size, flow rate or the like.

As previously discussed above, the first nozzle 113 includes an orifice control nozzle 117 and the second nozzle 114 includes a standard tip nozzle 115. The orifice control nozzle 117 optionally includes a modulating orifice element 126, such as an orifice plate, nested orifice elements, valve or the like to regulate the profile, size, associated spray pattern or flow rate of fluid applied from the orifice control nozzle 117. In an example, the modulating orifice element 126 includes an orifice plate that is modulated (e.g., rotated, translated, or the like) according to a specified spray pattern, droplet size or the like, referred to as a spray profile. The modulating orifice element 126 (e.g., an orifice plate, nested orifice elements, or the like) is positioned proximate to (e.g., in contact, separated, or the like) a nozzle orifice 116 of the orifice control nozzle 117. For instance, the orifice modulating orifice element 126 is at, immediately upstream, along the first fluid flow passage 123 between the bridging valve 120 and the orifice control nozzle 117, or the like. In one example of proximate position of the modulating orifice element 126, the modulating orifice element 126 is included as a nozzle edge (including a portion of the nozzle edge) of the orifice control nozzle 117.

In an example, the standard tip nozzle 115 dispenses an agricultural product at specified flow rates, pressures, or the like according to information communicated from the responsive flow control system 155. As an example, a responsive flow control system 155 includes a communication path with a control valves 127 such as pulse width modulation valves that regulates flow rate through the valve and to the associated nozzle, the standard tip nozzle 115 in this example. The responsive flow control system 155, for example, regulates the agricultural product dispensed from the standard tip nozzle 115 according to one or more of field conditions, agricultural fluid characteristics, carrier fluid characteristics, environmental conditions, or the like. The responsive flow control system 155, for example, rapidly (e.g., instantaneously, less than approximately 0.5 seconds, less than approximately 1 second, or the like) changes characteristics of the agricultural product (e.g., carrier fluid concentration, agricultural fluid concentration, flow rates, pressures, spray pattern or the like) dispensed from the standard tip nozzle 115.

Illustrated in FIG. 3A is an example of a configurable nozzle system 200. The configurable nozzle system 200 includes a nozzle housing 208 retaining a configurable nozzle assembly 210. The nozzle housing 208 also includes a nozzle manifold 218. The nozzle housing 208 is coupled with, for example, a first boom tube coupling 205a and a second boom tube coupling 205b. The first boom tube coupling 205a and the second boom tube coupling 205b hold the nozzle housing 208 in place relative to a first boom tube 201 and a second boom tube 202 in place. For instance, the first boom tube 201 is positioned on or relative to the nozzle housing by the first boom tube coupling 205a. The first boom tube coupling 205a fluidly connects the first boom tube 201 with the orifice control nozzle 117 (an example of the first nozzle 113) via the nozzle manifold 218. The orifice control nozzle 117, discussed herein and shown in FIG. 3A, is similar to the orifice control nozzle 117 shown in FIG. 1. The second boom tube 202 is, for example, is fluidly connected with a standard tip nozzle 115 via the nozzle manifold 218. The standard tip nozzle 115, discussed herein and shown in FIG. 3B, is similar to the standard tip nozzle 115 shown in FIG. 1.

FIG. 3B illustrates a schematic of the configurable nozzle system 200. For example, a first fluid path 223 fluidly interconnects the first boom tube 201 with the orifice control nozzle 117. A second nozzle fluid passage 225 fluidly interconnects the second boom tube 202 with the standard tip nozzle 115. In an example, the first fluid path 223 and the second nozzle fluid passage 225 are components of a flow path 224 that extends within the configurable nozzle assembly 210 and is downstream of respective metering systems (e.g., valves, throttling element, pumps or the like), such as an inline valve 222 and a responsive flow control system 255. The responsive flow control system 255 is, for example, a system that receives, transmits, or both, communication to metering mechanisms (e.g., valves, throttling elements, pumps or the like) within the flow path 224 or associated with standard tip nozzle 115 to rapidly (e.g., instantaneously, less than approximately 0.5 seconds, less than approximately 1.0 seconds, or the like) alter a characteristic of the agricultural product (as previously described). In an example, the responsive flow control mechanism controls one or more of flow rate (including specified flow rates, specified ranges of flow rates, or the like) of the agricultural product flowing along the flow path 224 and towards one or both of the orifice control nozzle 117 or the standard tip nozzle 115. For instance, the responsive flow control system 255 reduces the flow rate of the agricultural product when less agricultural product is specified for the agricultural target. In other instances, the responsive flow control system 255 increases the flow rate of the agricultural product when more agricultural product is specified for treating the agricultural target.

In an example, the first fluid path 223 and the second nozzle fluid passage 225 are selectively fluidly interconnected with a bridging valve 220. The bridging valve 220 is, for instance, an on/off valve, graduated control valve, or the like. The bridging valve 220 is, in one example, a manual on/off valve connecting a flow path 224 between one or more of the first boom tube 201 or the second boom tube 202 and one or more of the standard tip nozzle 115 or the orifice control nozzle 117. In another example, the bridging valve 220 is an automatic on/off valve controlled by the configurable nozzle control system 150 (see FIGS. 2, 3A).

Optionally, the inline valve 222 is an on/off valve positioned between the first boom tube 201 and the orifice control nozzle 117. In an example, the inline valve 222 is manually controlled (e.g., a user adjusts the inline valve 222). In another example, the inline valve 222 is controlled by the configurable nozzle control system 150, as discussed related to FIG. 2. The inline valve 222 regulates characteristics of an agricultural product flowing along a fluid path between the first boom tube 201 and the orifice control nozzle 117. The bridging valve 220 and the inline valve 222 provide a customized approach for how the agricultural product from the first boom tube 201 or the second boom tube 202 is supplied to one or both of the orifice control nozzle 117 or the standard tip nozzle 115.

In another example, the inline valve 222 includes a solenoid valve. Accordingly, fluid can flow from the first boom tube 201 to the solenoid valve. The inline valve 222 as a solenoid valve can modulate flow through the first fluid path 223 of the first agricultural product, for instance by changing a flow rate of fluid through the first fluid path 223. In an example, the solenoid valve, as the inline valve 222 modulates flow between full flow and a cessation of flow through the first fluid path 223 (and flow rates therebetween).

In yet another example, the inline valve 222 as a solenoid valve modulates flow through the first fluid path 223 at a faster rate than an operator can actuate a shuttle. For instance, the solenoid valve can transition between full flow and a cessation of flow through the first fluid path 223 within a first time period. An operator can actuate a shuttle within a second time period. The first time period can be less than the second time period. Accordingly, the solenoid valve can modulate flow through the first fluid path 223 in less time than the operator can actuate the shuttle. Thus, the solenoid valve enhances precision and accuracy in transitioning between full flow and a cessation of flow within the first fluid path 223. As a result, the solenoid valve can enhance performance of a multifunctional nozzle assembly system, for example by enhancing the accuracy and precision of applying an agricultural product using the multifunctional nozzle assembly system.

In an example, a first agricultural product passes through the first boom tube 201 flows through the inline valve 222 and to the orifice control nozzle 117. In another example, a second agricultural product passes through the second boom tube 202. An agricultural product characteristic (e.g., flow rate, pressure, concentration or the like) of the second agricultural product is optionally controlled by the responsive flow control system 255 before flowing to the standard tip nozzle 115. The responsive flow control system 255 controls mechanisms (e.g., valves, throttling elements, pumps or the like) positioned within or along the second nozzle fluid passage 225 to control the second agricultural product dispensed from the second boom tube 202 toward one or more of the standard tip nozzle 115 or the orifice control nozzle 117. In an example, the first agricultural product or the second agricultural product is not mixed when the bridging valve 220 in an “off” configuration. The bridging valve, for example, interrupts the flow from the second boom tube 202 to the first fluid path 223 and the associated orifice control nozzle 117. Alternatively, the bridging valve 220 is configured to be in an “on” configuration and permitting the second agricultural product to flow from the second boom tube 202 toward the orifice control nozzle 117 (e.g., along the flow path 224) or the first agricultural product flows from the first boom tube 201 to the standard tip nozzle 115.

The responsive flow control system 255 shown in FIG. 3B controls flow rate (including specified flow rates, specified ranges of flow rates, or the like) of the agricultural product through the second nozzle fluid passage 225 from the second boom tube 202. The responsive flow control system 255 includes one or more metering mechanisms, such as, but not limited to, valves, throttling elements, pumps or the like that are controlled by the remainder of the responsive flow control system 255. In one example, the responsive flow control system 255 provides control of the fluid, such as the agricultural product, to rapidly change the agricultural product characteristics (e.g., flow rate, pressure, composition, concentration or the like). In an example, an agricultural fluid (e.g., pesticide, herbicide, fertilizer or the like) from the second boom tube 202 “spikes” or increases the concentration of agricultural fluid mixed with the carrier fluid dispensed from the first boom tube 201 toward the orifice control nozzle 117. The agricultural fluid is supplied across the flow path 224 to the orifice control nozzle 117. For instance, the agricultural sprayer system 10 applies the “spiked” fluid in combination with the carrier fluid (from the first boom tube 201) from the orifice control nozzle 117 in areas of the field specified for additional treatment in comparison to other areas of the field.

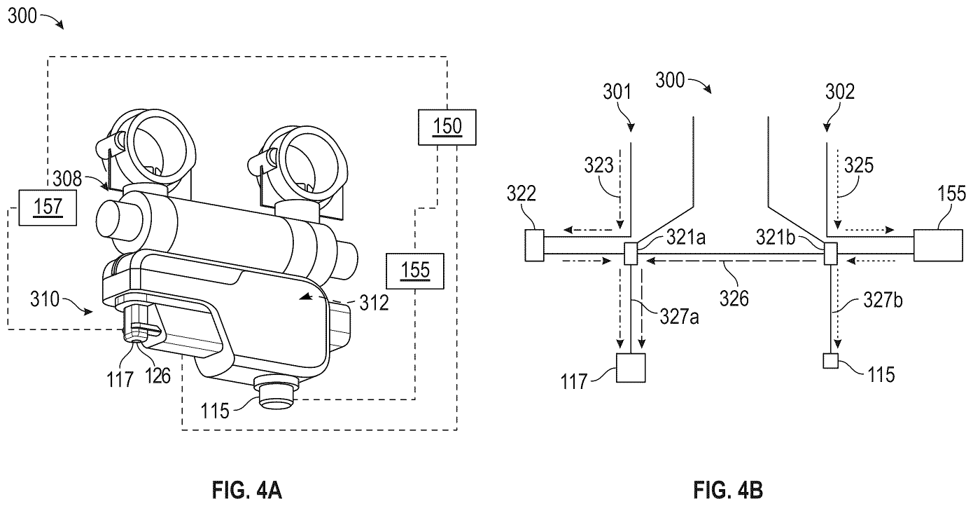

Illustrated in FIGS. 4A and 4B are examples of a configurable nozzle system 300. The configurable nozzle system 300 includes, similar to FIGS. 2, 3A and 3B, an orifice control nozzle 117 and a standard tip nozzle 115. As discussed, related to FIGS. 2, 3A and 3B, the standard tip nozzle 115 is in communication with the responsive flow control system 155. For example, the responsive flow control system 155 regulates one or more agricultural product characteristics through a second fluid passage 325.

The configurable nozzle system 300 includes, for example, metering mechanism (such as valves, throttling elements, pumps or the like) upstream from the orifice control nozzle 117 and the standard tip nozzle 115. The metering mechanisms are controlled, for example, by the configurable nozzle control system 150. In this example, the nozzle housing 308 retains a configurable nozzle assembly 310. The configurable nozzle assembly 310 includes a nozzle manifold 312. The configurable nozzle assembly 310 includes the at least one first three-way valve 321a positioned along a first fluid path 323 and at least one second three-way valve 321b positioned along the second fluid passage 325. Optionally, the first fluid path 323 includes an inline valve 322, such as an on/off valve, graduated control valve, or the like. In one instance, the second fluid passage 325 includes metering mechanisms that are controlled by the responsive flow control system 155 to regulate agricultural product flowing from a second boom tube 302 towards the standard tip nozzle 115.

In an example, the first fluid path 323 includes the inline valve 322 positioned downstream of a first boom tube 301 and upstream of the at least one first three-way valve 321a. The inline valve 322, in an example, is similar to the inline valve discussed related to FIGS. 3A and 3B. The inline valve 322, in an example includes an on/off valve that is manually controlled. In another example, the inline valve 322 includes an on/off valve that is automatically controlled, such as by the configurable nozzle control system 150. In yet another example, the inline valve 322 is a solenoid valve. The inline valve 322 as a solenoid valve modulates flow through the fluid path 323 at a faster rate than an operator can actuate a shuttle, as discussed related to FIGS. 3A and 3B. The inline valve 322 regulates the amount of agricultural product, such as carrier fluid, dispensed from the first boom tube 301 towards the orifice control nozzle 117.

Positioned along the first fluid path 323 extending from the first boom tube 301 to the orifice control nozzle 117 is also, for example, the at least one first three-way valve 321a. The at least one first three-way valve 321a is formed to open the first fluid path 323 to one or more of the agricultural products dispensed from the first boom tube 301 or the second boom tube 302 or both the first boom tube 301 and the second boom tube 302. Alternatively, the at least one first three-way valve 321a is formed to close the first fluid path 323 between one or the first boom tube 301 or the second boom tube 302 and interrupt agricultural product flowing between the two.

In an example, the at least one second three-way valve 321b is positioned upstream of the standard tip nozzle 115 and downstream of metering mechanisms (e.g., valves, throttling elements, pumps or the like) controlled by the responsive flow control system 155. For instance, the at least one second three-way valve 321b is formed to have an open configuration. In the open configuration, the second fluid passage 325 is opened to permit agricultural product, such as agricultural fluid, to flow directly to a second nozzle passage 327b. The second nozzle passage 327b is, for example, a portion of the second fluid passage 325 that is downstream of the at least one second three-way valve 321b and upstream of the standard tip nozzle 115.

In another example, the at least one second three-way valve 321b has an isolation distribution configuration that permits agricultural product, such as an agricultural fluid, to flow from the second boom tube 302 through an intermediary flow passage 326 towards a first nozzle passage 327a and bypasses the second nozzle passage 327b. For instance, the second nozzle passage 327b is isolated or blocked from the agricultural product, such as the agricultural fluid, flowing from the second boom tube 302 towards the orifice control nozzle 117. In an example, the at least one second three-way valve 321b is formed to have open configuration that permits agricultural product, such as an agricultural fluid, to flow both to the standard tip nozzle 115 and to the orifice control nozzle 117.

In one example, agricultural fluid flowing through the configurable nozzle assembly 310 is customizable. For instance, the configurable nozzle assembly 310 offers options for the flow path of agricultural product (e.g., carrier fluid, agricultural fluid or a mixture) towards the orifice control nozzle 117 and the standard tip nozzle 115. For instance, the configurable nozzle control system 150 (as described above) regulates the agricultural product from the second boom tube 302, such as agricultural fluid, through the at least one second three-way valve 321b and then through the intermediary flow passage 326 toward one of the orifice control nozzle 117 or the standard tip nozzle 115. In an example, the modulating orifice element 126 (discussed related to FIG. 2) of the orifice control nozzle 117 further regulates the flow, droplet size or spray pattern of the agricultural product.

In another option, the at least one first three-way valve 321a permits the agricultural product from the first boom tube 301, such as carrier fluid, and agricultural product from the second boom tube 302, such as agricultural fluid, to mix or combine before being dispensed from the orifice control nozzle 117. In another example, the at least one first three-way valve 321a or the at least one second three-way valve 321b are controlled by the configurable nozzle control system 150. For instance, the configurable nozzle control system 150 selectively opens and closes the at least one first three-way valve 321a and the at least one second three-way valve 321b. In an example, the configurable nozzle control system 150 allows the at least one second three-way valve 321b and the at least one first three-way valve 321a have an open configuration and permits fluid, such as agricultural fluid, from the second boom tube 302 to enter the first nozzle passage 327a. For instance, the agricultural fluid from the second boom tube 302 flowing through the first nozzle passage 327a is dispensed by the orifice control nozzle 117. In some instances, the configurable nozzle control system 150, shortly after opening the at least one first three-way valve 321a and the at least one second three-way valve 321b, closes the at least one first three-way valve 321a and the at least one second three-way valve 321b. The configurable nozzle control system 150, optionally, opens the at least one first three-way valve 321a to allow agricultural product, such as carrier fluid, from the first boom tube 301 to pass through the at least one first three-way valve 321a. The configurable nozzle control system 150, optionally, opens and closes the at least one first three-way valve 321a and also opens and closes the at least one second three-way valve 321b according to a preferred flow path. In an example, the agricultural product from the first boom tube 301 and the second boom tube 302 flows through one or more of the at least one first three-way valve 321a and the at least one second three-way valve 321b and then out of one or more of the standard tip nozzle 115 or the orifice control nozzle 117.

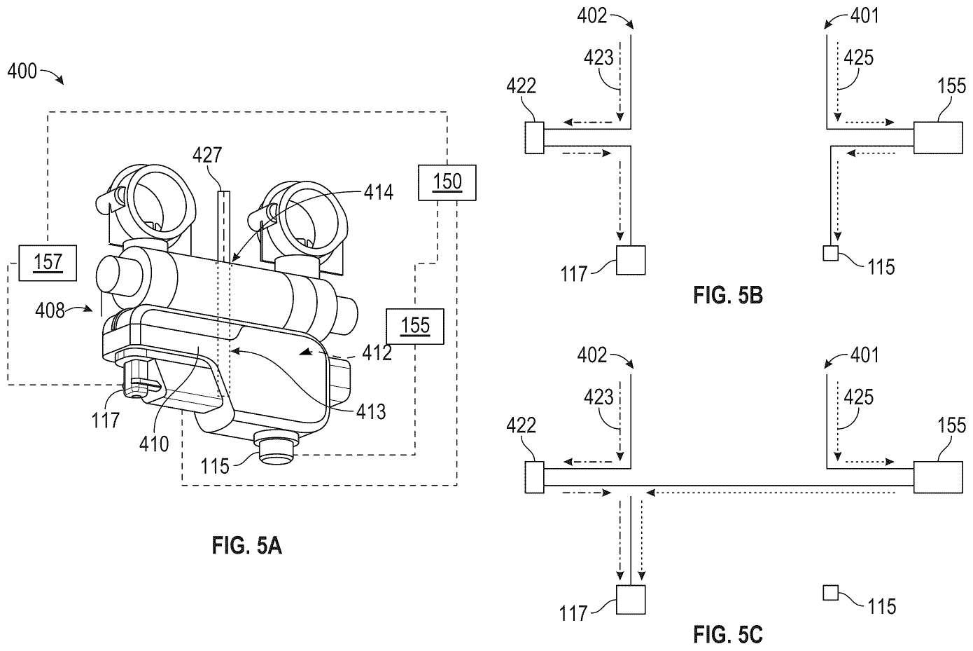

Illustrated in FIGS. 5A, 5B and 5C are examples of a configurable nozzle system 400. The configurable nozzle system 400 includes, for example, a nozzle housing 408. The nozzle housing 408 includes and a nozzle manifold 412. The configurable nozzle system 400 also retains a configurable nozzle assembly 410. The configurable nozzle assembly 410 includes the standard tip nozzle 115 and the orifice control nozzle 117 as discussed previously related to FIGS. 2-4B. FIGS. 5B and 5C illustrate a schematic of a first fluid path 423 that is selectively isolated from a second nozzle fluid passage 425. The first fluid path 423 is selectively isolated from the second nozzle fluid passage 425 with an insert valve 427 (illustrated in FIG. 5A). The configuration illustrated in FIGS. 5A, 5B and 5C permits a user to control the agricultural product flowing from each of the first boom tube 401 and the second boom tube 402 towards the standard tip nozzle 115 and the orifice control nozzle 117. The configuration illustrated in FIGS. 5A, 5B and 5C allows a user to operate in, optionally, a co-spraying arrangement (e.g., spraying from both the standard tip nozzle 115 and the orifice control nozzle 117). The configuration illustrated in FIGS. 5A, 5B and 5C allows a user to optionally operate in a configuration for spraying from one of the standard tip nozzle 115 and the orifice control nozzle 117. In an example, agricultural product from each of the first boom tube 501 and the second boom tube 502 mix, for example, upstream of the orifice control nozzle 117. For example, carrier fluid (as an example agricultural product from the first boom tube 501) and the agricultural fluid (as an example agricultural product from the second boom tube 502) mix proximate to or at the orifice control nozzle 117. In an example, the carrier fluid and the agricultural fluid mix before being dispensed through the nozzle orifice 116. In an example, the responsive flow control system 155 regulates the amount of agricultural fluid flowing from the second boom tube 402 into the first fluid path 423.

The insert valve 427 is, for example, positioned into a portion of the nozzle manifold 412. For example, a mechanism positions the insert valve 427 into a portion of the nozzle manifold 412 at predetermined times. In another example, the insert valve 427 is manually inserted into the nozzle manifold 412 by a user. The insert valve 427, for example, is positioned within a port 414 (e.g., slot, recess, cavity or the like) that extends into the interior portion 413 of the nozzle manifold 412. Optionally, the insert valve 427 is inserted from the exterior of the nozzle manifold 412 to an interior portion 413. In an example, the insert valve 427 is positioned between the first fluid path 423 and the second nozzle fluid passage 425.

The insert valve 427, for example, includes a plunger having a first configuration and a second configuration. In the first configuration, illustrated in the schematic in FIG. 5C, the insert valve 427 is not positioned between the first fluid path 423 and the second nozzle fluid passage 425 and the port 414 interconnects the first fluid path 423 and the second nozzle fluid passage 425. The port 414 permits a second agricultural product, such as agricultural fluid, to flow from the second boom tube 402 toward the orifice control nozzle 117. The second agricultural product from the second boom tube 402 bypasses the standard tip nozzle 115. The first agricultural product from the first boom tube 401 is optionally regulated by an inline valve 422, similar to that described related to any of the previous Figures. In an example, the inline valve 422 is a solenoid valve. The inline valve 422 as a solenoid valve modulates flow through the first fluid path 423 at a faster rate than an operator can actuate a shuttle, as discussed related to FIGS. 3A and 3B. For instance, the first agricultural product from the first boom tube 401, such as carrier fluid, flows through the first fluid path 423 towards the orifice control nozzle 117 and the second agricultural product from the second boom tube 402 flows towards the orifice control nozzle 117, bypassing the standard tip nozzle 115.

In an example, the insert valve 427 is not inserted into the port 414 when agricultural fluid from second boom tube 402 is injected to the first fluid path 423 to supplement the carrier fluid from first boom tube 401. In one situation, the insert valve 427 is not positioned within the configurable nozzle assembly 410 and permits a free flow of the agricultural fluid, into the first fluid path 423. In another situation, the insert valve 427 is not positioned within the configurable nozzle assembly 410 and permits a controlled flow (e.g., controlled by the configurable nozzle control system 150 or the responsive flow control system 155) of agricultural fluid into the first fluid path 423. In another example, in the first configuration, carrier fluid is transmitted from the first boom tube 401 towards the standard tip nozzle 115 and bypasses the orifice control nozzle 117. Optionally, the flow of carrier fluid is regulated by the inline valve 422.

In the second configuration, as illustrated in FIG. 5B, the insert valve 427 interrupts (e.g., blocks, inhibits, prohibits or the like) the agricultural product from flowing from the second boom tube 402 to the orifice control nozzle 117. In the second configuration, the insert valve 427 is positioned, such as translated, into the port 414 and the insert valve 427 and the agricultural product from the second boom tube 402 flows along the second nozzle fluid passage 425 and is dispensed from the standard tip nozzle 115. Illustrated in FIG. 5B, the insert valve 427 allows for co-spraying, such as spraying from both the standard tip nozzle 115 and the orifice control nozzle 117. For instance, the agricultural product from the first boom tube 401 is distributed from the orifice control nozzle 117 and the agricultural product from the second boom tube 402 is distributed from the standard tip nozzle 115. In an example, the agricultural product is carrier fluid, as a base fluid, and is dispensed from the first boom tube 401. The carrier fluid is optionally controlled at least in part by the orifice control system 157. In an example, the agricultural product dispensed from the second boom tube 402 is an agricultural fluid, as a supplemental fluid, to the carrier fluid. In an example, the agricultural fluid is controlled at least in part by the responsive flow control system 155. For instance, the user selectively controls the agricultural product, such as the carrier fluid and the agricultural fluid, dispensed from the respective nozzle without mixing.

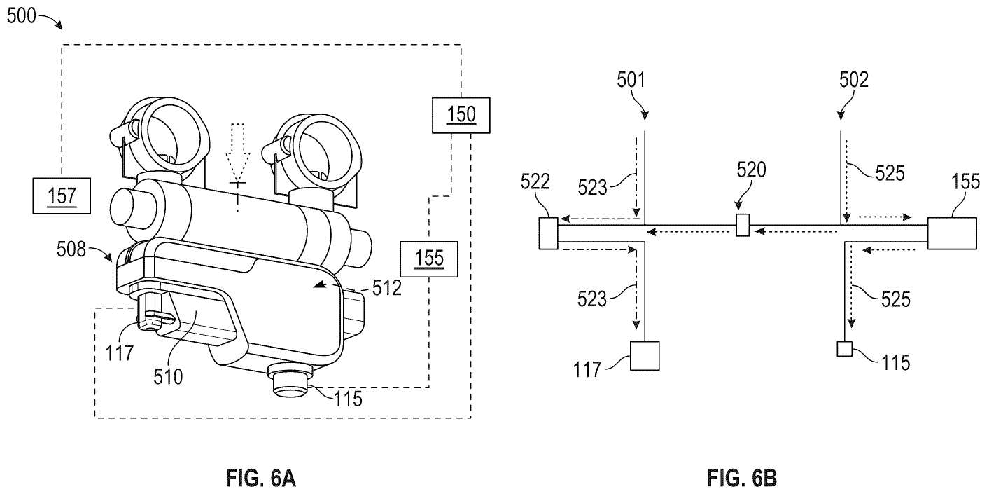

Illustrated in FIGS. 6A and 6B are examples of a configurable nozzle system 500 including a nozzle housing 508 that retains a configurable nozzle assembly 510. For example, the nozzle housing 508 includes a nozzle manifold 512. The nozzle manifold 512, in an example, fluidly connects the standard tip nozzle 115 and the orifice control nozzle 117 as discussed previously related to FIGS. 2-5B that are components of the configurable nozzle assembly 510. In the example configurable nozzle assembly 510, an on/off valve 520 is positioned between a first fluid path 523 and a second nozzle fluid passage 525. The first fluid path 523 extends from the first boom tube 501 to the orifice control nozzle 117. The second nozzle fluid passage 525 extends from the second boom tube 502 to the standard tip nozzle 115.

The on/off valve 520, for example, is a manual on/off valve that regulates the fluid flow from the first boom tube 501 or the second boom tube 502 before the configurable nozzle control system 150 controls the flow characteristics (e.g., flow rate, pressure, or the like) of the respective agricultural product.

In an example, the on/off valve 520 is upstream from metering mechanisms (e.g., valves, throttling elements, pumps or the like) controlled by the orifice control system 157 and the responsive flow control system 155. For example, a second agricultural product, such as agricultural fluid, flows from the second boom tube 502 bypassing the responsive flow control system 155. In an example, the agricultural fluid flowing through the on/off valve 520 is mixed with a first agricultural product, such as carrier fluid, from the first boom tube 501. Optionally, a flow of mixed agricultural fluid and carrier fluid, or each agricultural product alone, is regulated by an inline valve 522 before being dispensed from the orifice control nozzle 117. In an example, the inline valve 522 includes a solenoid valve. The inline valve 522 as a solenoid valve modulates flow through the first fluid path 523 at a faster rate than an operator can actuate a shuttle, as discussed related to FIGS. 3A and 3B. In another example, the agricultural fluid from second boom tube 502 flows from the second boom tube 502 and the flow characteristics are regulated or controlled by the responsive flow control system 155. The agricultural fluid from the second boom tube 502, for example, after regulation or control by the responsive flow control system 155 is dispensed by one of the standard tip nozzle 115 or the orifice control nozzle 117.

Optionally, the first fluid path 523 and the second nozzle fluid passage 525 including the on/off valve 520 is upstream of the responsive flow control system 155. In this scenario, the agricultural fluid from the second boom tube 502 is controlled to be mixed with carrier fluid from the first boom tube 501 and dispensed from the orifice control nozzle 117.

In another example, the agricultural fluid from the second boom tube 502 in certain configurations is controlled through the responsive flow control system 155 and dispensed out of the standard tip nozzle 115. In yet, another example, the agricultural fluid from second boom tube 502 passes through a manual on/off valve 520 and is mixed with the carrier fluid from first boom tube 501 and then dispensed from the orifice control nozzle 117.

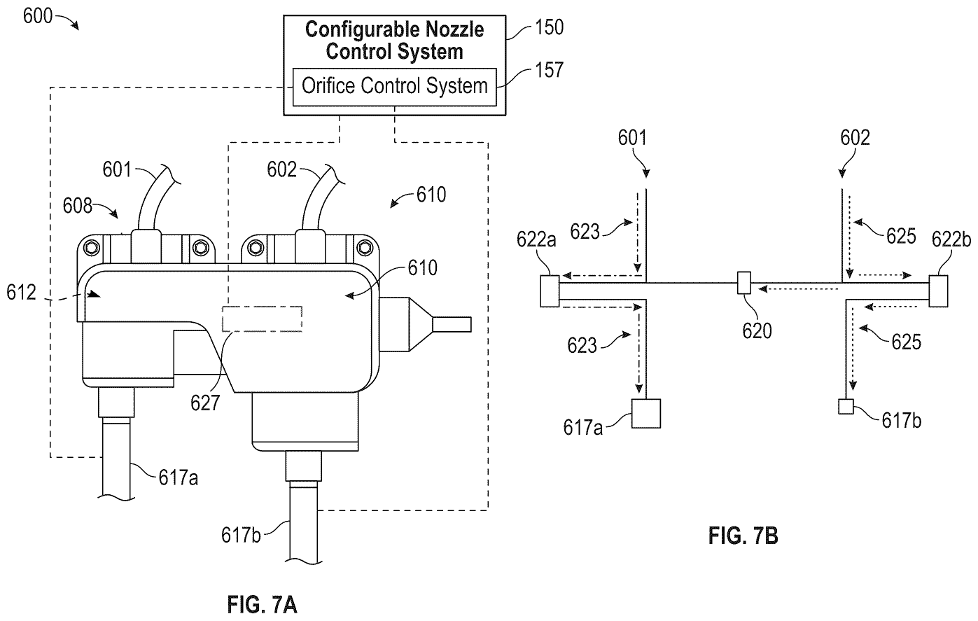

Illustrated in FIGS. 7A and 7B are examples of a configurable nozzle system 600 including a nozzle housing 608 that retains a configurable nozzle assembly 610. The nozzle housing 608 includes and a nozzle manifold 612. The configurable nozzle assembly 610 includes a first orifice control nozzle 617a and a second orifice control nozzle 617b. The first orifice control nozzle 617a and the second orifice control nozzle 617b are similar to the individual orifice control nozzle 117 discussed previously. In the example configurable nozzle assembly 610, an inline on/off valve 620, graduated control valve, or the like, is positioned between a first nozzle fluid passage 623 and a second nozzle fluid passage 625. The first nozzle fluid passage 623 extends from the first boom tube 601 to the first orifice control nozzle 617a. The second nozzle fluid passage 625 extends from the second boom tube 602 to the second orifice control nozzle 617b.

In the example illustrated in FIGS. 7A and 7B, a first agricultural product, such as a carrier fluid, is dispensed through the first nozzle fluid passage 623 to a first orifice control nozzle 617a. In another example, a second agricultural product, such as an agricultural fluid, flows through the second nozzle fluid passage 625 to a second orifice control nozzle 617b. The first orifice control nozzle 617a and the second orifice control nozzle 617b are each controlled by the configurable nozzle control system 150. In an example, the dispense of the carrier fluid and the agricultural fluid from each of the first orifice control nozzle 617a and the second orifice control nozzle 617b are controlled, individually or jointly, by the orifice control system 157.

In an example, the inline on/off valve 620 is controlled by the configurable nozzle control system 150 to have a configuration that allows the agricultural fluid to flow from the second boom tube 602 towards the first orifice control nozzle 617a. Optionally, the agricultural fluid is mixed with carrier fluid from the first boom tube 601. For instance, the quantity or concentration of the agricultural fluid and the carrier fluid is controlled by the inline on/off valve 620. In an example, a mixture of the agricultural fluid and carrier fluid that passes through the inline on/off valve 620 before dispensing out of one of the first orifice control nozzle 617a or the second orifice control nozzle 617b.

In an example, before being dispensed from one of the first orifice control nozzle 617a and the second orifice control nozzle 617b there is an orifice control on/off valve 622a and a responsive control on/off valve 622b positioned downstream of the off valve 620 in the first nozzle fluid passage 623 and the second nozzle fluid passage 625, respectively. Optionally, the valve 622a or the off valve 622b is a solenoid valve. The valve 622a or the valve 622b as a solenoid valve modulates flow through the first nozzle fluid passage 623 or the second nozzle fluid passage 625 at a faster rate than an operator can actuate a shuttle, as discussed related to FIGS. 3A and 3B. The orifice control on/off valve 622a and the responsive control on/off valve 622b are, for example controlled by the configurable nozzle control system 150 to regulate the first agricultural product, such as carrier fluid, and the second agricultural product, such as agricultural fluid, flowing from the first boom tube 601 and the second boom tube 602. The orifice control on/off valve 622a and the responsive control on/off valve 622b either manually or automatically control flow characteristics of the agricultural product from the first boom tube 601 and the second boom tube 602.

Illustrated in FIGS. 7A and 7B are examples of a configurable nozzle system 600 including a configurable nozzle assembly 610 houses a nozzle manifold 612. The configurable nozzle assembly 610 includes a first orifice control nozzle 617a and a second orifice second orifice control nozzle 617b. The first orifice control nozzle 617a and the second orifice control nozzle 617b are similar to the individual orifice control nozzle 117 discussed previously. In the example configurable nozzle assembly 610, an inline on/off valve 620 is positioned between a first nozzle fluid passage 623 and a second nozzle fluid passage 625. Optionally, a solenoid valve 627 is positioned along the nozzle manifold 612 at a specified position according to the purpose. For instance, the off valve 620 includes a solenoid valve 627 and regulates flow to one or more of the valve 622a or the off valve 622b. The first nozzle fluid passage 623 extends from the first boom tube 601 to the first orifice control nozzle 617a. The second nozzle fluid passage 625 extends from the second boom tube 602 to the second orifice control nozzle 617b.

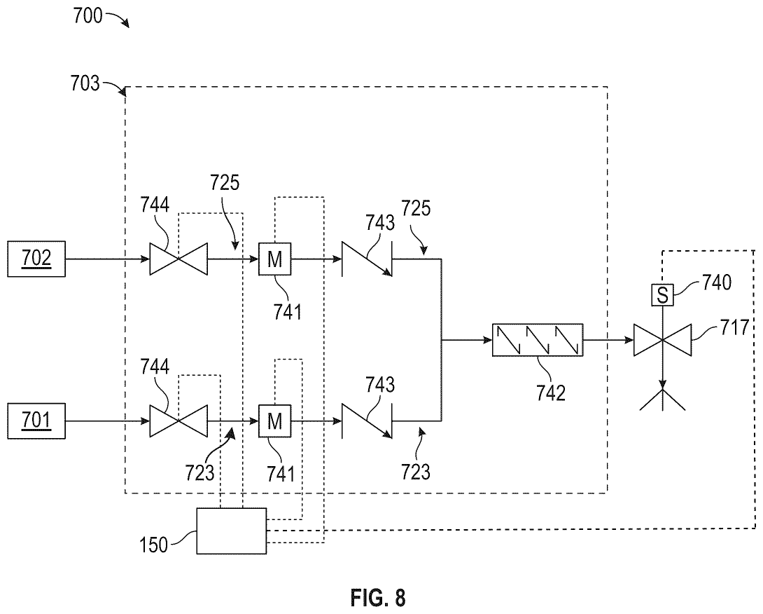

Illustrated in FIG. 8 is a configurable nozzle system 700 including an interface body 703 (an example of a nozzle housing). The interface body 703 houses one or more control mechanisms for regulating one or more flow characteristics of one or more of a first agricultural product, such as a carrier fluid, from a first boom tube 701 or a second agricultural product, such as an agricultural fluid, from a second boom tube 702. In an example, the interface body 703 has one or more metering mechanisms such as one or more throttling elements 744 (e.g., pumps, valves, or the like) and one or more metering valves 743. The one or more throttling elements 744 are configured to vary the flow of the agricultural product. For instance, the one or more throttling elements 744 include, but is not limited to, one or more pumps or valves configured to deliver the agricultural product towards one or more of a standard tip nozzle 115 or an orifice control nozzle 117. For example, the one or more throttling elements 744 are configured to vary the fluid characteristic (e.g., flow rate, pressure, or the like) according to measured or sensed characteristics of the agricultural products downstream of the one or more throttling elements 744.

As further shown in FIG. 8, the interface body 703 includes one or more metering valves 743 that control flow of agricultural products to a downstream nozzle 717. The one or more metering valves 743 include one or more controllable valves configured for remote control of flow of the agricultural product by the configurable nozzle control system 150. In one example, the one or more metering valves 743 include, but are not limited to, pulse width modulation valves configured to cycle between on and off configurations at one or more duty cycles and provide corresponding flow rates, pressures or the like of the one or more agricultural products. In an example including two or more agricultural products, the products are combined at specified concentration (e.g., based on flow rates from each of the one or more metering valves 743) at a mixer 742 before the agricultural fluid is dispensed from a nozzle 717.

Optionally, one or more sensors 741 are in communication with the configurable nozzle control system 150 and the configurable nozzle control system 150 is in communication with each of the one or more throttling elements 744. The configurable nozzle control system 150 controls the one or more throttling elements 744 to provide, for example, a specified concentration of each of the agricultural products, such as a carrier fluid from the first boom tube 701 and an agricultural fluid from the second boom tube 702. In an example, the one or more sensors 741 are in respective feedback control loops with the configurable nozzle control system 150 to control, for example, the flow rate through the one or more throttling elements 744 to achieve a specified concentration or amount of one or both of the first agricultural product from the first boom tube 701 or the second agricultural product from the second boom tube 702. The one or more sensors 741 in some examples include flow meters, pressure transducers, chemical sensors, or the like. The one or more sensors 741 include, but are not limited to, optical sensors, pressure sensors, thermistors or the like, alone or in combination. The one or more sensors 741, associated with the lower one or more metering valves 743 and one or more throttling elements 744, are positioned at a specified position along a first flow path 723 extending from the first boom tube 701 to the nozzle 717 in the interface body 703. One or more sensors 741 associated with the second flow path 725 are similarly position at one or more specified positions along the second flow path 725 within the interface body 703 extending to the nozzle 717.

In an example, the configurable nozzle system 700 having the one or more sensors 741, the metering mechanisms such as the one or more throttling elements 744, and the one or more metering valves 743, permits local control of the concentration, constituency or the like of the agricultural product sprayed from the nozzle 717. Optionally, a flow control sensor 740 is in communication with the nozzle 717.

The flow control sensor 740, in one example, is an optional sensor for sensing or measuring a flow characteristic (e.g., flow rate, pressure, dispense profile or the like) or receives information related to the operation of the nozzle 717 itself. In an example, the flow control sensor 740 measures or senses a concentration or composition of the agricultural product immediately before spraying. In another example, the flow control sensor 740 measures the concentration of a mixed agricultural product and provide feedback to the configurable nozzle control system 150. The flow control sensor 740 optionally provides a feedback to the configurable nozzle control system 150 related to the sensed or measured values related to the sprayed, or agricultural product proximate or at the nozzle 717. The configurable nozzle control system 150, for example, alters a characteristic of the agricultural product (e.g., flow rate, pressure, concentration or the like) locally to the nozzle 717.

The local control facilitates rapid (e.g., instantaneous, within less than 0.5 seconds, less than 1 second, or the like) control of the concentration of the agricultural fluid (as the second fluid from second boom tube 702) to a corresponding carrier fluid (as the first fluid from the first boom tube 701) and then corresponding delivery of a mixed agricultural product at specified concentrations for rapid dispensing from the respective nozzle 717.

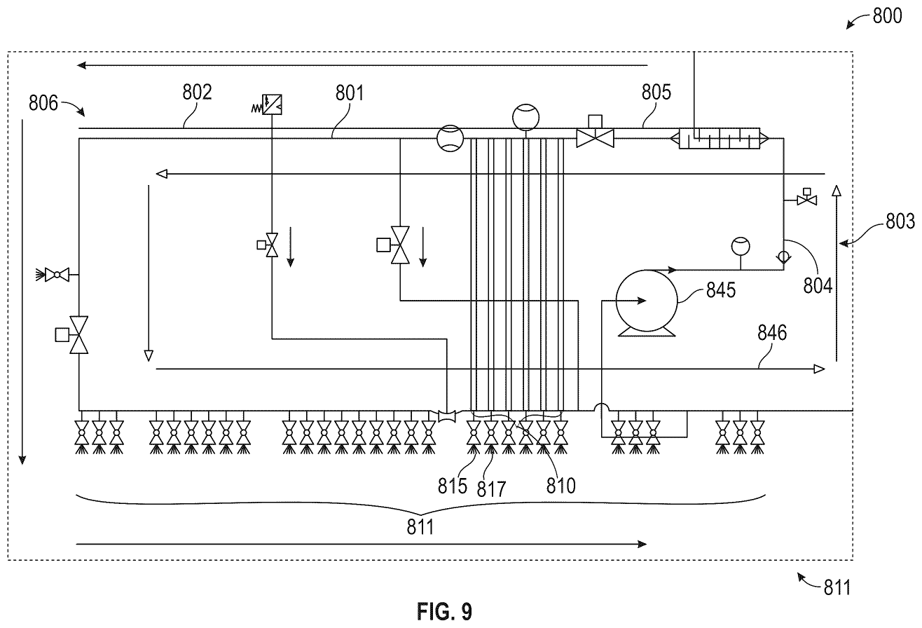

Illustrated in FIG. 9 is a schematic of a configurable nozzle system 800 including a recirculation system 803. In an example, the recirculation system 803 is positioned to allow a fluid to flow through one or more of a first boom tube 801 or a second boom tube 802 and one or more nozzles 811. In an example, one or more nozzle assemblies 810 (e.g., any of the previously discussed nozzle assemblies) are positioned along the recirculation system 803. The one or more nozzles 811 includes, for instance, an orifice nozzle 817 (similar to orifice control nozzle 117 discussed previously) or a standard tip nozzle 815 (similar to standard tip nozzle 115 discussed previously).

The recirculation system 803 is, for example, a loop that includes a recirculation fluid flow passage 846 and includes at least recirculation bridge 804 and a pump 845. For example, at least recirculation bridge 804 and the pump 845 are operated, individually or jointly, as mechanism that, allows a fluid to flow repeated through flow paths including the one or more of the first boom tube 801, second boom tube 802 and the one or more nozzles 811. Optionally, the flow paths include the one or more nozzle assemblies 810 through the recirculation system 803. In an example, the recirculation system 803 circulates a fluid from a distal portion 805 to a proximal portion 806 of at least one of the first boom tube 801 and the second boom tube 802 and back to the distal portion 805. In an example, the recirculation system 803 circulates a fluid in other directions according to the purpose.

The recirculation system 803 circulates a fluid (e.g., air, liquid, fluidized particulates) through at least a portion of the configurable nozzle system 800. In an example, at least one of the fluid sources (such as a fluid source 130, 132, 134, 136 discussed related to FIG. 2) contains air or cleaning fluid that is dispensed though a recirculation fluid flow passage 846. In an example, a pump 845 is included in the recirculation system 803. The pump 845 and is designed to provide pressure to circulate the fluid from the fluid source (such as fluid source 130, 132, 134, 136 discussed related to FIG. 2) within the configurable nozzle system 800. In an example the recirculation system 803 is designed to provide air or a cleaning agent to the one or more nozzles 811.

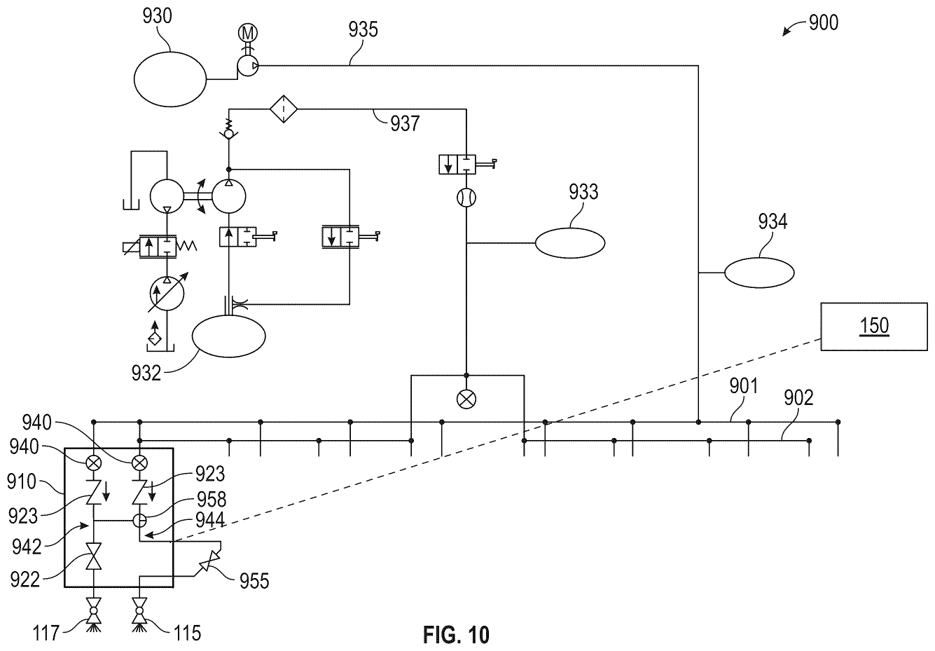

Illustrated in FIG. 10 is an example of a configurable nozzle system 900 including a configurable nozzle assembly 910. While one configurable nozzle assembly 910 is illustrated relative to the first boom tube 901 and the second boom tube 902, the first boom tube 901 and the second boom tube 902 includes, jointly or separately, more than one configurable nozzle assembly 910. The configurable nozzle system 900 includes, for example the first boom tube 901 or second boom tube 902 fluidly connected with one or more fluid sources, such as a first fluid source 930, a second fluid source 932, a third fluid source 933 and a fourth fluid source 934. In an example, the third fluid source 933 and the fourth fluid source 934 contain a secondary agricultural product, such as an agricultural fluid, that is added to or mixed with the respective agricultural product from the first fluid source 930 or the second fluid source 932. Optionally, valves (e.g., throttling elements or the like), pumps, sensors or other components designed to meter, measure or detect a fluid characteristic (e.g., fluid flow, rate, pressure or the like) are positioned in or along a first fluid flow path 935 between the first fluid source 930 and the first boom tube 901 and, jointly or separately, in a second fluid flow path 937 between the second fluid source 932 and the second boom tube 902.

The configurable nozzle assembly 910 includes, for example, sensors, metering elements, a standard tip nozzle 115 and orifice control nozzle 117 (as described related to at least FIG. 2). In an example, a first nozzle flow path 942 extends between the first boom tube 901 and the orifice control nozzle 117 and a second nozzle flow path 944 extends between the second boom tube 902 and the standard tip nozzle 115. In an example, the first nozzle flow path 942 and the second nozzle flow path 944 are selectively, fluidly interconnected with a bridging valve 958. In an example, the bridging valve 958 is a three-way valve. Optionally, the bridging valve 958 is positioned in line with the second nozzle flow path 944, such as downstream from the first metering valve 923 and the at least one sensor 940.

Optionally, the bridging valve 958 directs flow from the second boom tube 902 towards the standard tip nozzle 115 or the orifice control nozzle 117. For instance, the bridging valve 958 is similar to the three-way valves discussed relative to FIGS. 4A and 4B. In one example, the bridging valve 958 is positioned between the first metering valve 923 and an external valve 955. The external valve 955, for instance, is positioned downstream from the bridging valve 958 to further meter the agricultural product flowing through the second nozzle flow path 944 towards the standard tip nozzle 115. Having the external valve 955, for example, downstream of the bridging valve 958 allows for further refinement of the second agricultural product, such as an agricultural fluid, sprayed from the standard tip nozzle 115. In one example, the external valve 955 is in communication with the configurable nozzle control system 150. The external valve 955, for example, is controlled by a responsive flow control system 155 to rapidly (e.g., instantaneously, less than 0.5 seconds, less than approximately 1.0 seconds or the like) alter a flow characteristic of the agricultural product flowing towards the standard tip nozzle 115.

In an example, the first nozzle flow path 942 includes at least one sensor 940 positioned upstream of the orifice control nozzle 117 and downstream of the first boom tube 901. The at least one sensor 940, for example, measures a flow characteristic (e.g., fluid flow, rate, pressure or the like) of a first agricultural product, such as carrier fluid, dispensed from the first fluid source 930. The measured flow characteristic sensed by the at least one sensor 940 is, for example, communicated to a configurable nozzle control system 150 (as described related to FIG. 1). Optionally, the at least one sensor 940 is positioned upstream of a first metering valve 923 (e.g., throttling element, pump or the like). In another example, the at least one sensor 940 is positioned downstream of the first metering valve 923 and upstream of a second metering valve 922 (e.g., throttling element, pump or the like). The first metering valve 923 and the second metering valve 922, in an example, are the same or similar components that regulate the flow of a first agricultural product, such as a carrier fluid, dispensed from the first fluid source 930 based on a measurement of a flow characteristic.

In the arrangement illustrated in FIG. 10, the configurable nozzle assembly 910 is, for example, configured to spray from both the orifice control nozzle 117 and the standard tip nozzle 115. For instance, the configurable nozzle assembly 910 distributes a specified amount of, carrier fluid from the orifice control nozzle 117 and agricultural fluid from the orifice control nozzle 117. In another example, the orifice control nozzle 117 is configured to spray a mixture of a carrier fluid from the first fluid source 930 that is mixed with an agricultural product that is a supplemental fluid (e.g., injection fluid, agricultural fluid, or the like) from the fourth fluid source 934. In yet another example, the standard tip nozzle 115 is configured to spray a mixture of an agricultural product from the second fluid source 932 that is mixed with another agricultural product as a supplemental fluid (e.g., injection fluid, agricultural fluid, or the like) from the third fluid source 933.

Optionally, the configurable nozzle control system 150 controls the bridging valve 958 to permit fluid to flow from the second boom tube 902 towards the orifice control nozzle 117. Optionally, the fluid from the second fluid source 932 or the third fluid source 933 is dispensed from the standard tip nozzle 115 with or without d into the first nozzle flow path 942. For instance, agricultural product from one or more of the second fluid source 932 and the third fluid source 933 is directly distributed from the orifice control nozzle 117 or the standard tip nozzle 115. In a further example, the standard tip nozzle 115 is configured to selectively dispense agricultural product directly distributed from the first boom tube 901 or the second boom tube 902.

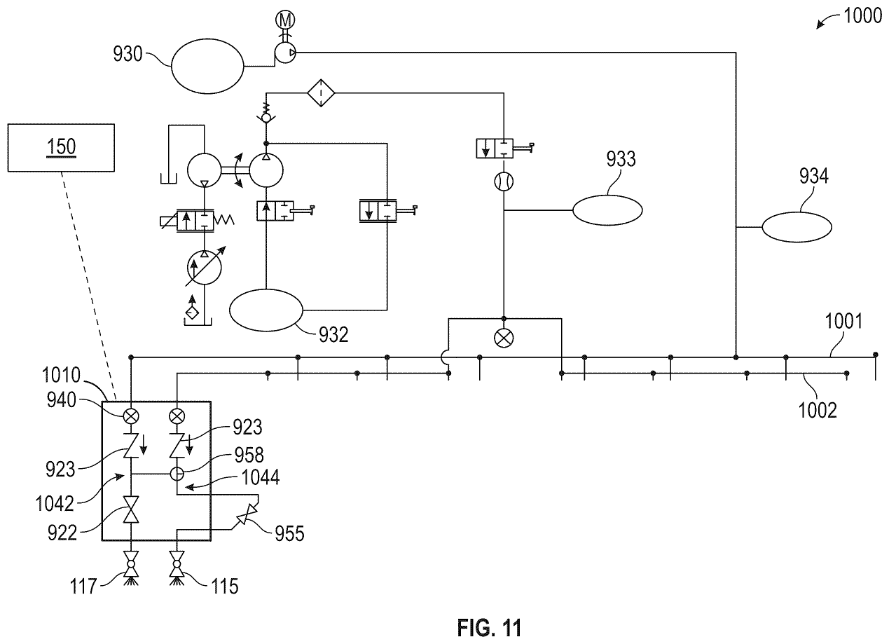

FIG. 11 illustrates a configurable nozzle system 1000 similar to the configurable nozzle system 900 illustrated in FIG. 10. In an example, the configurable nozzle assembly 1010 includes a first nozzle flow path 1042 and a second nozzle flow path 1044. In the example illustrated in FIG. 11, the agricultural product dispensed from a first boom tube 1001, such as agricultural product from one or more of the first fluid source 930 and the third fluid source 933 (as discussed related to FIG. 10) flows directly to the first nozzle flow path 1042. The agricultural product dispensed from a second boom tube 1002, such as fluid from one or more of the second fluid source 932 and the fourth fluid source 934 (as discussed related to FIG. 10) flows directly to the second nozzle flow path 1044. Optionally, in the configurable nozzle assembly 1010 the fluid from the second boom tube 1002 is permitted to flow towards the orifice control nozzle 117 only with activation of the bridging valve 958 (as discussed related to FIG. 10).

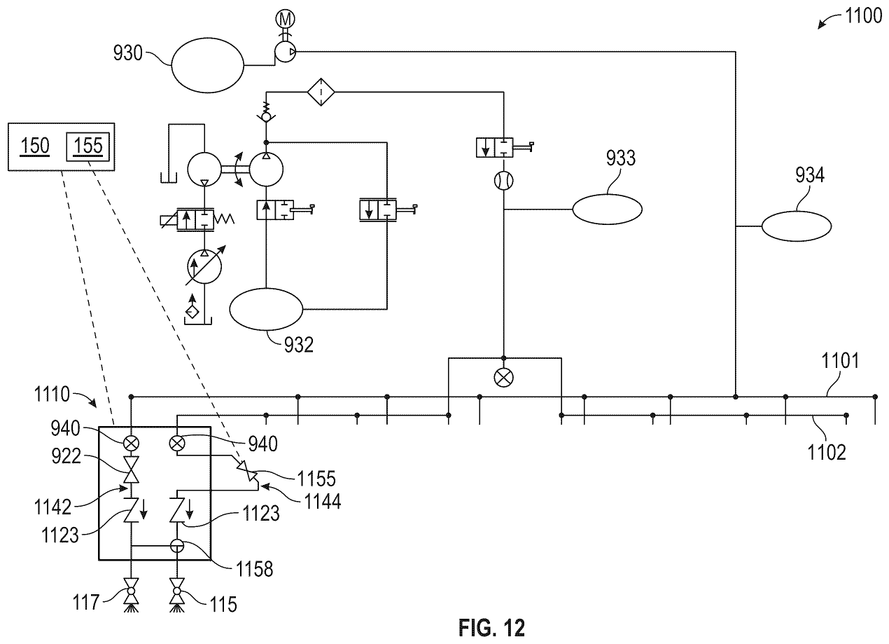

Illustrated in FIG. 12 is an example of a configurable nozzle system 1100 having a configurable nozzle assembly 1110. The configurable nozzle assembly 1110 includes at least one sensor 940 (similar to those discussed related to FIG. 9) in communication with the configurable nozzle control system 150 (as discussed previously). The at least one sensor 940 is, for instance, upstream of metering elements (e.g., valves, throttle elements, pumps or the like). In an example, the second flow path 1144 includes an external valve 1155 proximate to the at least one sensor 940. For instance, the external valve 1155 is in communication with the configurable nozzle control system 150, such as a responsive flow control system 155 (discussed as related to FIG. 2). The external valve 1155, optionally, rapidly regulates the flow of fluid, such as agricultural product, from a second boom tube 1102 towards the standard tip nozzle 115.

In an example, agricultural product from a first boom tube 1101 is measured with the at least one sensor 940 upon the agricultural product flowing into a first flow path 1142 of the configurable nozzle assembly 1110. For instance, the at least one sensor 940 is in communication with the configurable nozzle control system 150. The configurable nozzle control system 150 provides communication to, for example, the second metering valve 922 and, optionally, a check valve 1123. In an example, the second agricultural product flowing through the second flow path 1144 is directed to the first flow path 1142 with a three-way valve 1158 after the second agricultural product passes through metering mechanisms, such as the external valve 1155 or the check valve 1123.

The configurable nozzle systems, as discussed related to any of FIGS. 1-12 are configured to permit specified fluid flowing to the specified nozzles. The configurable nozzle systems are, for instance, configured to spray a specified fluid, or mixture of fluid, according to the specified purpose.

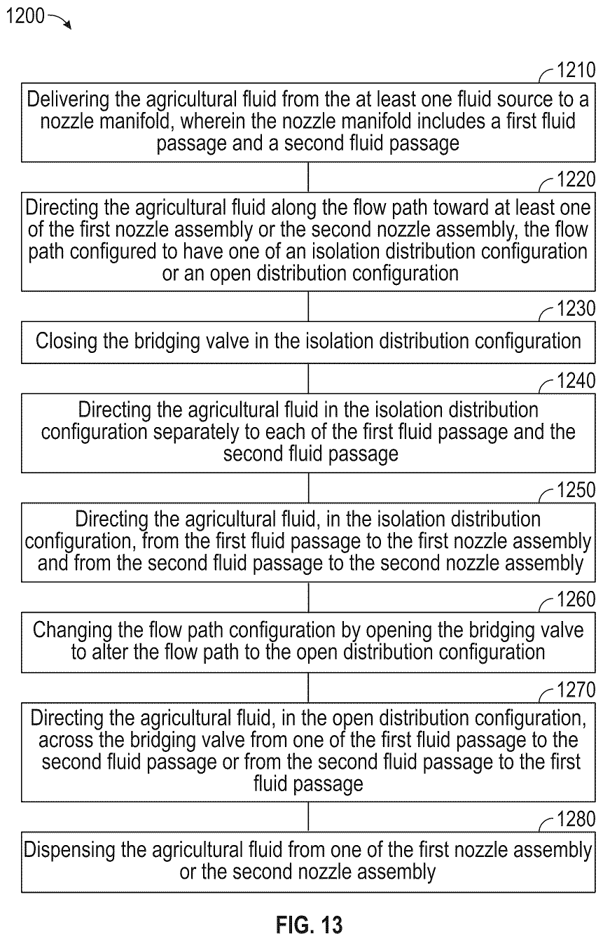

Illustrated in FIG. 13 is an example of a method 1200 of distributing an agricultural product along a flow path. The flow path, for example extends from at least one first fluid source to a first nozzle assembly and a second fluid source to a second nozzle assembly. Each of the first fluid source and the second fluid source contains an agricultural product such as water, carrier fluid, herbicide, pesticide, fungicide or the like.

The method includes delivering the fluid from the at least one fluid source to a nozzle manifold. The nozzle manifold, is for example, housed within a nozzle housing. The nozzle manifold includes, for example, a first fluid passage and a second fluid passage, as indicated in 1210. The nozzle manifold contains plumbing that directs the agricultural fluid along the flow path toward at least one of the first nozzle assembly or the second nozzle assembly and the flow path. In an example there is a first flow path extending from the first fluid source to the first nozzle assembly and a second flow path extending from the second fluid source to the second nozzle assembly. Optionally, the flow path is configured to have one of an isolation distribution configuration or an open distribution configuration, as indicated in 1220.

In an isolation distribution configuration, a bridging valve is positioned in the flow path, such as along a flow path between the first flow path and the second flow path. The bridging valve, for example, is configured to change the flow path to change the bridging valve from a closed position, as an example of an isolation distribution configuration to an open distribution configuration, as indicated in 1230. In the isolation distribution configuration, one of the first flow path or the second flow path is isolated, at least in part, from receiving the agricultural product. For example, in the isolation distribution configuration, the method includes directing the agricultural product separately to each of the first fluid passage and the second fluid passage, as indicated in 1240. Further, in the isolation distribution configuration the agricultural product is directed from the first fluid passage to the first nozzle assembly and from the second fluid passage to the second nozzle assembly, as indicated in 1250.

Optionally, the at least one bridging valve is one of a manual on/off valve, a three-way valve or an insert valve. The at least one bridging valve, for example, selectively interconnects the at least one fluid passage either upstream or downstream from at least one inline valve positioned along the first flow path or the second flow path. For example, an isolation distribution configuration the at least one bridging valve is configured to block agricultural fluid flowing from the first fluid passage to the second fluid passage and in an open distribution configuration the at least one bridging valve allows fluid to flow across the at least one bridging valve. In a further example, in an open configuration the bridging valve alters the flow path to not block the agricultural fluid, as indicated in 1260.

In an example, at least one at least one inline valve interconnects the at least one or more fluid passage with at least one of the first nozzle passage or the second nozzle passage. In another example, a first inline valve interconnects a first fluid passage with the first nozzle passage and a second inline valve interconnects a second fluid passage with the second nozzle passage. For example, in an open configuration, the agricultural fluid is directed across the bridging valve from the one of the first fluid passage to the second fluid passage or from the second fluid passage to the first fluid passage, as indicated in 1270.

In an example, the at least one bridging valve selectively interconnects the at least one or more fluid passage upstream from the at least one inline valve. For instance, in an isolation distribution configuration the at least one bridging valve is configured to block fluid flowing from a first flow path to a second flow path and in an open distribution configuration the at least one bridging valve allows agricultural fluid to flow across the at least one bridging valve.

Optionally, at least one flow determining sensor is positioned along at least a portion of the flow path. For instance, the at least one sensor is positioned within the flow path upstream of the first nozzle or the second nozzle, or both. In an example, at least one flow determining sensor in communication with at least one of the fluid passage or the first nozzle passage or second nozzle passage. The at least one flow determining sensor, for example, measures at least one of flow rate or pressure differential of a fluid passing the at least one of the fluid passage, first nozzle passage or second nozzle passage.

The method further includes, for example, changing the flow path configuration by opening the bridging valve to alter the flow path to the open distribution configuration. In the distribution configuration, the fluid is directed across the bridging valve from one of the first fluid passage to the second fluid passage or from the second fluid passage to the first fluid passage. Optionally, the distribution is controlled with a configurable nozzle control system.

In either the isolation distribution configuration or in the open distribution configuration, the method includes dispensing the agricultural fluid from one of the first nozzle assembly or the second nozzle assembly, as indicated in 1280.

In a further example of distribution agricultural product, a first agricultural product is delivered through a first boom tube to the nozzle manifold and a second agricultural product is delivered through a second boom tube to the nozzle manifold. For example, the first boom tube and the second boom tube are each coupled to a nozzle housing and the nozzle housing includes the nozzle manifold. In an example, in the isolation distribution configuration, the first agricultural product is directed to the first nozzle assembly and the second agricultural product tis directed to the second nozzle assembly. Optionally, in the open distribution configuration, one of the first agricultural product or the second agricultural product is directed across the bridging valve. In an example, the first agricultural product and the second agricultural product are mixed together proximate to the bridging valve.

In another example, the flow of the first agricultural product is regulated with a first inline valve. For instance, the first inline valve interconnects the nozzle manifold with the first nozzle assembly. The second agricultural product is directed through a second boom tube to the nozzle manifold. Optionally, a flow of the second agricultural fluid is regulated with a second inline valve and the second inline valve interconnects the nozzle manifold with the second nozzle assembly.

The first nozzle assembly or the second nozzle assembly, for example, includes an orifice control nozzle. In another example, the first nozzle assembly or the second nozzle assembly dispenses the agricultural fluid through a standard tip nozzle. Optionally, both the first nozzle assembly and the second nozzle assembly include the same or a similar type of nozzle. In an example, one or both of the orifice control nozzle or the standard tip nozzle are in communication with the configurable nozzle control system. For example, the orifice control nozzle includes a nozzle plate that is controlled by an orifice control system and the standard tip nozzle is controlled by the responsive control system.

### ASPECTS

Aspect 1 can include subject matter such as a configurable nozzle system comprising: a first nozzle including: a first nozzle passage; and a first nozzle spray orifice in communication with the first nozzle passage; a second nozzle including: a second nozzle passage; and a second nozzle spray orifice in communication with the second nozzle passage; and a nozzle housing retaining each of the first and second nozzles, the nozzle housing including: a nozzle manifold interconnecting each of the first and second nozzle passages; and a bridging valve coupled along the nozzle manifold and selectively interconnecting the first and second nozzle passages; wherein the bridging valve is configured to regulate an agricultural fluid flow between the first nozzle passage and the second nozzle passage.

Aspect 2 can include, or can optionally be combined with the subject matter of Aspect 1, to optionally include the bridging valve includes a two-way or three-way valve.

Aspect 3 can include, or can optionally be combined with the subject matter of one or any combination of Aspects 1 or 2 to optionally include the bridging valve includes an insert valve having a plunger insert having at least first and second configurations: in the first configuration a through port of the plunger insert interconnects the first and second nozzle passages permitting fluid flow; and in the second configuration the plunger insert is translated relative to the nozzle housing, and a partition of the plunger insert is interposed between the first and second nozzle passages interrupting fluid flow.

Aspect 4 can include, or can optionally be combined with the subject matter of one or any combination of Aspects 1-3 to optionally include the plunger insert includes a piston body having one of the through port or the partition stacked over the other of the partition or the through port.

Aspect 5 can include, or can optionally be combined with the subject matter of one or any combination of Aspects 1-4 to optionally include the bridging valve is configured to isolate the first nozzle passage from the second nozzle passage in an isolation distribution configuration and is configured to allow the agricultural fluid to pass across the bridging valve in an open distribution configuration.

Aspect 6 can include, or can optionally be combined with the subject matter of one or any combination of Aspects 1-5 to optionally include at least one configurable nozzle assembly coupled with one or more of the first or second nozzles, the configurable nozzle assembly having a modulating orifice element as a nozzle edge the first or second nozzle orifice; and a configurable nozzle control system in communication with the at least one configurable nozzle assembly, the configurable nozzle control system configured to actuate the modulating orifice element and control a profile of the first or second nozzle orifice.

Aspect 7 can include, or can optionally be combined with the subject matter of one or any combination of Aspects 1-6 to optionally include the configurable nozzle control system includes one or more processors.

Aspect 8 can include, or can optionally be combined with the subject matter of one or any combination of Aspects 1-7 to optionally include the configurable nozzle control system is in communication with the bridging valve, and the configurable nozzle control system is configured to actuate the bridging valve and control fluid flow between the first and second nozzle passages.

Aspect 9 can include, or can optionally be combined with the subject matter of one or any combination of Aspects 1-8 to optionally include the configurable nozzle control system is configured to facilitate instantaneous control of at least the modulating orifice element of the first nozzle or the second nozzle.

Aspect 10 can include, or can optionally be combined with the subject matter of one or any combination of Aspects 1-9 to optionally include the at least one configurable nozzle assembly includes a nozzle edge, and the nozzle edge extends along one or more of the first or second nozzle spray orifices.

Aspect 11 can include, or can optionally be combined with the subject matter of one or any combination of Aspects 1-10 to optionally include the nozzle edge includes an orifice control plate of one or more of the first or second nozzles, and the orifice control plate and the nozzle edge are configured to move to control a spray nozzle profile of one or more of the first or second spray orifices.

Aspect 12 can include, or can optionally be combined with the subject matter of one or any combination of Aspects 1-11 to optionally include the configurable nozzle control system is configured to control at least one of an orifice control nozzle, a responsive flow control system, and the bridging valve.

Aspect 13 can include, or can optionally be combined with the subject matter of one or any combination of Aspects 1-12 to optionally include the responsive flow control system is a pulse width modulation valve in communication with the configurable nozzle control system, and the pulse width modulation valve is configured to control a flow rate through one or more of the first or second nozzles

Aspect 14 can include, or can optionally be combined with the subject matter of one or any combination of Aspects 1-13 to optionally include the at least one of the first nozzle or the second nozzle includes a standard tip.

Aspect 15 can include, or can optionally be combined with the subject matter of one or any combination of Aspects 1-14 to optionally include a plurality of couplings on an exterior surface of the nozzle housing, each coupling configured to couple at least one boom tube; wherein each boom tube is in communication with the nozzle manifold.

Aspect 16 can include, or can optionally be combined with the subject matter of one or any combination of Aspects 1-15 to optionally include the at least one boom tube is connected with at least one fluid source.

Aspect 17 can include, or can optionally be combined with the subject matter of one or any combination of Aspects 1-16 to optionally include the bridging valve regulates a fluid flow from the at least one boom tube to at least one of the first nozzle and the second nozzle.

Aspect 18 can include subject matter such as a configurable nozzle system comprising: a first boom tube and a second boom tube; and a nozzle housing retaining a configurable nozzle assembly, the configurable nozzle assembly including: at least one coupling configured couple the first boom tube and the second boom tube with the nozzle housing; a first nozzle assembly including: a first nozzle passage in communication with at least one of the first boom tube or the second boom tube; and a first nozzle spray orifice; a second nozzle assembly including: a second nozzle passage in communication with the other of the first boom tube or the second boom tube; and a second nozzle spray orifice; a nozzle manifold including one or more fluid passages, the one or more fluid passages interconnecting at least one of the first boom tube and the second boom tube with at least one of the first nozzle assembly and second nozzle assembly; and at least one bridging valve selectively interconnecting the one or more fluid passages to at least one of the first nozzle assembly and the second nozzle assembly.

Aspect 19 can include, or can optionally be combined with the subject matter of Aspect 18, to optionally include the first boom tube receives and transmits a first fluid from a first fluid source to the first nozzle assembly and the second boom tube receives and transmits a second fluid from a second fluid source to the second nozzle assembly.

Aspect 20 can include, or can optionally be combined with the subject matter of one or any combination of Aspects 18 or 19 to optionally include at least one configurable nozzle assembly coupled with one or more of the first or second nozzles, the configurable nozzle assembly having a modulating orifice element as an edge of the first or second nozzle orifice; and a configurable nozzle control system in communication with the at least one configurable nozzle assembly, the configurable nozzle control system configured to actuate the modulating orifice element and control a profile of the first nozzle assembly or the second nozzle assembly.

Aspect 21 can include, or can optionally be combined with the subject matter of one or any combination of Aspects 18-20 to optionally include a responsive flow control system in communication with at least one of the first nozzle assembly or the second nozzle assembly.

Aspect 22 can include, or can optionally be combined with the subject matter of one or any combination of Aspects 18-21 to optionally include the configurable nozzle system is on an agricultural sprayer.

Aspect 23 can include, or can optionally be combined with the subject matter of one or any combination of Aspects 18-22 to optionally include at least one bridging valve regulates fluid flow between the at least one first boom tube or the at least one second boom tube and the at least one first nozzle assembly or the at least one second nozzle assembly.

Aspect 24 can include, or can optionally be combined with the subject matter of one or any combination of Aspects 18-23 to optionally include at least one inline valve interconnecting the one or more fluid passage with at least one of the first nozzle passage or the second nozzle passage; wherein the at least one bridging valve selectively interconnects the at least one fluid passage downstream from the at least one inline valve; wherein in an isolation distribution configuration the at least one bridging valve is configured to block agricultural fluid flowing from a first fluid passage to a second agricultural fluid passage and in an open distribution configuration the at least one bridging valve allows agricultural fluid to flow across the at least one bridging valve.

Aspect 25 can include, or can optionally be combined with the subject matter of one or any combination of Aspects 18-24 to optionally include at least one inline valve interconnecting the at least one or more fluid passage with at least one of the first nozzle passage or the second nozzle passage; wherein the at least one bridging valve selectively interconnects the at least one or more fluid passage upstream from the at least one inline valve; wherein in an isolation distribution configuration the at least one bridging valve is configured to block agricultural fluid flowing from a first fluid passage to a second agricultural fluid passage and in an open distribution configuration the at least one bridging valve allows agricultural fluid to flow across the at least one bridging valve.

Aspect 26 can include, or can optionally be combined with the subject matter of one or any combination of Aspects 18-26 to optionally include a first inline valve interconnecting a first fluid passage with the first nozzle passage; and a second inline valve interconnecting a second fluid passage with the second nozzle passage; wherein the at least one bridging valve selectively interconnects the first fluid passage and the second fluid passage either upstream of the first inline valve and the second inline valve or downstream of the first inline valve and the second inline valve.

Aspect 27 can include, or can optionally be combined with the subject matter of one or any combination of Aspects 18-26 to optionally include at least one flow determining sensor in communication with at least one of the fluid passage or the first nozzle passage or second nozzle passage; wherein the at least one flow determining sensor measures at least one of flow rate or pressure differential of a fluid passing the at least one of the fluid passage, first nozzle passage or second nozzle passage.

Aspect 28 can include subject matter such as a method of distributing an agricultural fluid along a flow path, the flow path extending from at least one agricultural fluid source to a first nozzle assembly and a second nozzle assembly, a bridging valve selectively interconnecting the first nozzle assembly and the second nozzle assembly, the method comprising: delivering the agricultural fluid from the at least one fluid source to a nozzle manifold; wherein the nozzle manifold includes a first fluid passage and a second fluid passage; directing the agricultural fluid along the flow path toward at least one of the first nozzle assembly or the second nozzle assembly, the flow path configured to have one of an isolation distribution configuration or an open distribution configuration; closing the bridging valve in the isolation distribution configuration; directing the agricultural fluid in the isolation distribution configuration separately to each of the first fluid passage and the second fluid passage; directing the agricultural fluid, in the isolation distribution configuration, from the first fluid passage to the first nozzle assembly and from the second fluid passage to the second nozzle assembly; changing the flow path configuration by opening the bridging valve to alter the flow path to the open distribution configuration; directing the agricultural fluid, in the open distribution configuration, across the bridging valve from one of the first fluid passage to the second fluid passage or from the second fluid passage to the first fluid passage; and dispensing the agricultural fluid from one of the first nozzle assembly or the second nozzle assembly.

Aspect 29 can include, or can optionally be combined with the subject matter of Aspect 28, to optionally include dispensing a first agricultural fluid from a first agricultural fluid source and dispensing a second agricultural fluid from a second agricultural fluid source.

Aspect 30 can include, or can optionally be combined with the subject matter of one or any combination of Aspects 28 or 29 to optionally include controlling the distribution of the agricultural fluid with a configurable nozzle control system.

Aspect 31 can include, or can optionally be combined with the subject matter of one or any combination of Aspects 28-30 to optionally include delivering a first agricultural fluid through a first boom tube to the nozzle manifold; delivering a second agricultural fluid through a second boom tube to the nozzle manifold; wherein the first boom tube and the second boom tube are each coupled to a nozzle housing, the nozzle housing retaining the nozzle manifold; directing, in the isolation distribution configuration, the first agricultural fluid to the first nozzle assembly and the second agricultural fluid to the second nozzle assembly; and directing, in the open distribution configuration, one of the first agricultural fluid or the second agricultural fluid across the bridging valve; wherein in the open distribution configuration the first agricultural fluid and the second agricultural fluid are mixed together proximate to the bridging valve.

Aspect 32 can include, or can optionally be combined with the subject matter of one or any combination of Aspects 28-31 to optionally include delivering the first agricultural fluid from a first boom tube to the nozzle manifold; regulating a flow of the first agricultural fluid with a first inline valve, the first inline valve interconnecting the nozzle manifold with the first nozzle assembly; delivering the second agricultural fluid through a second boom tube to the nozzle manifold; and regulating a flow of the second agricultural fluid with a second inline valve, the second inline valve interconnecting the nozzle manifold with the second nozzle assembly.

Aspect 33 can include, or can optionally be combined with the subject matter of one or any combination of Aspects 28-32 to optionally include the agricultural fluid out of the first nozzle assembly or the second nozzle assembly includes dispensing the agricultural fluid through an orifice control nozzle.

Aspect 34. can include, or can optionally be combined with the subject matter of one or any combination of Aspects 28-33 to optionally include dispensing the at least one fluid out of the first nozzle assembly or the second nozzle assembly includes dispensing the agricultural fluid through a standard tip nozzle; wherein dispensing the agricultural fluid through the standard tip nozzle is controlled with a responsive flow control system.

Aspect 35 can include, or can optionally be combined with the subject matter of one or any combination of Aspects 28-34 to optionally include the bridging valve includes at least one of a manual on/off valve, a three-way valve, or an insert valve.

Aspect 36 can include, or can optionally be combined with the subject matter of one or any combination of Aspects 28-35 to optionally include the bridging valve interconnects at least one of the first fluid passage or the second fluid passage upstream from at least one of a first inline valve coupled with the first fluid passage and a second inline valve coupled with the second fluid passage.

Aspect 37 can include, or can optionally be combined with the subject matter of one or any combination of Aspects 28-36 to optionally include the bridging valve interconnects at least one of the first fluid passage or the second fluid passage downstream from at least one of a first inline valve coupled with the first fluid passage and a second inline valve coupled with the second fluid passage.

Aspect 38 can include, or can optionally be combined with the subject matter of one or any combination of Aspects 28-37 to optionally include measuring at least one of flow rate or pressure differential of the agricultural fluid with at least one flow determining sensor.

What is claimed is:

1. A configurable nozzle assembly comprising:
a first nozzle including:
a first nozzle passage; and
a first nozzle spray orifice in communication with the first nozzle passage;
a second nozzle including:
a second nozzle passage; and
a second nozzle spray orifice in communication with the second nozzle passage; and
a nozzle housing retaining each of the first and second nozzles, the nozzle housing including:
a nozzle manifold interconnecting each of the first and second nozzle passages; and
a bridging valve coupled along the nozzle manifold and selectively interconnecting the first and second nozzle passages;
wherein the bridging valve is configured to regulate an agricultural product flow between the first nozzle passage and the second nozzle passage.

2. The configurable nozzle assembly of claim 1 wherein the bridging valve includes a two-way or three-way valve.

3. The configurable nozzle assembly of claim 1 wherein the bridging valve includes an insert valve having a plunger insert having at least first and second configurations:
in the first configuration a through port of the plunger insert interconnects the first and second nozzle passages permitting fluid flow; and
in the second configuration the plunger insert is translated relative to the nozzle housing, and a partition of the plunger insert is interposed between the first and second nozzle passages interrupting fluid flow.

4. The configurable nozzle assembly of claim 3, wherein the plunger insert includes a piston body having one of the through port or the partition stacked over the other of the partition or the through port.

5. The configurable nozzle assembly of claim 3 wherein the bridging valve is configured to isolate the first nozzle passage from the second nozzle passage in an isolation distribution configuration and is configured to allow an agricultural product to pass across the bridging valve in an open distribution configuration.

6. The configurable nozzle assembly of claim 1 further comprising:
at least one configurable nozzle having a modulating orifice element as a nozzle edge the first or second nozzle orifice; and
a configurable nozzle control system in communication with the at least one configurable nozzle, the configurable nozzle control system configured to actuate the modulating orifice element and control a profile of the first or second nozzle orifice.

7. The configurable nozzle assembly of claim 6, wherein the configurable nozzle control system includes one or more processors.

8. The configurable nozzle assembly of claim 6, wherein the configurable nozzle control system is in communication with the bridging valve, and the configurable nozzle control system is configured to actuate the bridging valve and control fluid flow between the first and second nozzle passages.

9. The configurable nozzle assembly of claim 6, wherein the configurable nozzle control system is configured to facilitate instantaneous control of at least the modulating orifice element of the first nozzle or the second nozzle.

10. The configurable nozzle assembly of claim 6, wherein the at least one configurable nozzle includes a nozzle edge, and the nozzle edge extends along one or more of the first or second nozzle spray orifices.

11. The configurable nozzle assembly of claim 10, wherein the nozzle edge includes an orifice control plate of one or more of the first or second nozzles, and the orifice control plate and the nozzle edge are configured to move to control a spray nozzle profile of one or more of the first or second spray orifices.

12. The configurable nozzle assembly of claim 6, wherein the configurable nozzle control system is configured to control at least one of an orifice control nozzle, a responsive flow control system, and the bridging valve.

13. The configurable nozzle assembly of claim 12, wherein the responsive flow control system is a pulse width modulation valve in communication with the configurable nozzle control system, and the pulse width modulation valve is configured to control a flow rate through one or more of the first or second nozzles.

14. The configurable nozzle assembly of claim 1, wherein the at least one of the first nozzle or the second nozzle includes a standard tip.

15. The configurable nozzle assembly of claim 1, wherein the configurable nozzle assembly is a component of a configurable nozzles system, the configurable nozzle system includes a plurality of couplings on an exterior surface of the nozzle housing, each coupling configured to couple at least one boom tube;
wherein each boom tube is in communication with the nozzle manifold.

16. The configurable nozzle assembly of claim 15, wherein the configurable nozzle system includes the at least one boom tube is connected with at least one fluid source.

17. The configurable nozzle assembly of claim 15, wherein the bridging valve regulates a fluid flow from the at least one boom tube to at least one of the first nozzle and the second nozzle.

18. A configurable nozzle system comprising:
a first boom tube and a second boom tube; and
a nozzle housing retaining a configurable nozzle assembly, the configurable nozzle assembly including:
at least one coupling configured couple the first boom tube and the second boom tube with the nozzle housing;
a first nozzle assembly including:
a first nozzle passage in communication with at least one of the first boom tube or the second boom tube; and
a first nozzle spray orifice;
a second nozzle assembly including:
a second nozzle passage in communication with the other of the first boom tube or the second boom tube; and
a second nozzle spray orifice;
a nozzle manifold including one or more fluid passages, the one or more fluid passages interconnecting at least one of the first boom tube and the second boom tube with at least one of the first nozzle assembly and second nozzle assembly; and
at least one bridging valve selectively interconnecting the one or more fluid passages to at least one of the first nozzle assembly and the second nozzle assembly.

19. The configurable nozzle system of claim 18 wherein the first boom tube receives and transmits a first fluid from a first fluid source to the first nozzle assembly and the second boom tube receives and transmits a second fluid from a second fluid source to the second nozzle assembly.

20. The configurable nozzle system of claim 18 further comprising:
at least one configurable nozzle assembly coupled with one or more of the first or second nozzles, the configurable nozzle assembly having a modulating orifice element as an edge of the first or second nozzle orifice; and
a configurable nozzle control system in communication with the at least one configurable nozzle assembly, the configurable nozzle control system configured to actuate the modulating orifice element and control a profile of the first nozzle assembly or the second nozzle assembly.

21. The configurable nozzle system of claim 20 further comprising a responsive flow control system in communication with at least one of the first nozzle assembly or the second nozzle assembly.

22. The configurable nozzle system of claim 18 wherein the configurable nozzle system is on an agricultural sprayer.

23. The configurable nozzle system of claim 18 wherein the at least one bridging valve regulates fluid flow between the at least one first boom tube or the at least one second boom tube and the at least one first nozzle assembly or the at least one second nozzle assembly.

24. The configurable nozzle system of claim 18 further comprising:
at least one inline valve interconnecting the one or more fluid passage with at least one of the first nozzle passage or the second nozzle passage;
wherein the at least one bridging valve selectively interconnects the at least one fluid passage downstream from the at least one inline valve;
wherein in an isolation distribution configuration the at least one bridging valve is configured to block agricultural fluid flowing from a first fluid passage to a second agricultural fluid passage and in an open distribution configuration the at least one bridging valve allows agricultural fluid to flow across the at least one bridging valve.

25. The configurable nozzle system of claim 18 further comprising:
at least one inline valve interconnecting the at least one or more fluid passage with at least one of the first nozzle passage or the second nozzle passage;
wherein the at least one bridging valve selectively interconnects the at least one or more fluid passage upstream from the at least one inline valve;
wherein in an isolation distribution configuration the at least one bridging valve is configured to block an agricultural product flowing from a first fluid passage to a second fluid passage and in an open distribution configuration the at least one bridging valve allows agricultural fluid to flow across the at least one bridging valve.

26. The configurable nozzle system of claim 18 further comprising:
a first inline valve interconnecting a first fluid passage with the first nozzle passage; and
a second inline valve interconnecting a second fluid passage with the second nozzle passage;
wherein the at least one bridging valve selectively interconnects the first fluid passage and the second fluid passage either upstream of the first inline valve and the second inline valve or downstream of the first inline valve and the second inline valve.

27. The configurable nozzle system of claim 18 further comprising:
at least one flow determining sensor in communication with at least one of the fluid passage or the first nozzle passage or the second nozzle passage;
wherein the at least one flow determining sensor measures at least one of flow rate or pressure differential of a fluid passing the at least one of the fluid passage, the first nozzle passage or the second nozzle passage.

28. A method of distributing an agricultural product along a flow path, the flow path extending from at least one agricultural fluid source to a first nozzle assembly and a second nozzle assembly, a bridging valve selectively interconnecting the first nozzle assembly and the second nozzle assembly, the method comprising:
delivering the agricultural product from the at least one fluid source to a nozzle manifold;
wherein the nozzle manifold includes a first fluid passage and a second fluid passage;
directing the agricultural product along the flow path toward at least one of the first nozzle assembly or the second nozzle assembly, the flow path configured to have one of an isolation distribution configuration or an open distribution configuration;
closing the bridging valve in the isolation distribution configuration;
directing the agricultural product in the isolation distribution configuration separately to each of the first fluid passage and the second fluid passage;
directing the agricultural product, in the isolation distribution configuration, from the first fluid passage to the first nozzle assembly and from the second fluid passage to the second nozzle assembly;
changing the flow path configuration by opening the bridging valve to alter the flow path to the open distribution configuration;
directing the agricultural product, in the open distribution configuration, across the bridging valve from one of the first fluid passage to the second fluid passage or from the second fluid passage to the first fluid passage; and
dispensing the agricultural product from one of the first nozzle assembly or the second nozzle assembly.

29. The method of claim 28 further comprising: dispensing a first agricultural product from a first agricultural product source and dispensing a second agricultural product from a second agricultural product source.

30. The method of claim 28 further comprising:
controlling the distribution of the agricultural product with a configurable nozzle control system.

31. The method of claim 28 further comprising:
delivering a first agricultural product through a first boom tube to the nozzle manifold;
delivering a second agricultural product through a second boom tube to the nozzle manifold;
wherein the first boom tube and the second boom tube are each coupled to a nozzle housing, the nozzle housing retaining the nozzle manifold;
directing, in the isolation distribution configuration, the first agricultural product to the first nozzle assembly and the second agricultural product to the second nozzle assembly; and
directing, in the open distribution configuration, one of the first agricultural product or the second agricultural product across the bridging valve;
wherein in the open distribution configuration the first agricultural product and the second agricultural product are mixed together proximate to the bridging valve.

32. The method of claim 28 further comprising:
delivering a first agricultural product from a first boom tube to the nozzle manifold;
regulating a flow of the first agricultural product with a first inline valve, the first inline valve interconnecting the nozzle manifold with the first nozzle assembly;
delivering a second agricultural product through a second boom tube to the nozzle manifold; and
regulating a flow of the second agricultural product with a second inline valve, the second inline valve interconnecting the nozzle manifold with the second nozzle assembly.

33. The method of claim 28, wherein dispensing the agricultural product out of the first nozzle assembly or the second nozzle assembly includes dispensing the agricultural product through an orifice control nozzle.

34. The method of claim 28, wherein dispensing the at least one fluid out of the first nozzle assembly or the second nozzle assembly includes dispensing the agricultural fluid through a standard tip nozzle;
wherein dispensing the agricultural product through the standard tip nozzle is controlled with a responsive flow control system.

35. The method of claim 28, wherein the bridging valve includes at least one of a manual on/off valve, a three-way valve, or an insert valve.

36. The method of claim 35 wherein the bridging valve interconnects at least one of the first fluid passage or the second fluid passage upstream from at least one of a first inline valve coupled with the first fluid passage and a second inline valve coupled with the second fluid passage.

37. The method of claim 35 wherein the bridging valve interconnects at least one of the first fluid passage or the second fluid passage downstream from at least one of a first inline valve coupled with the first fluid passage and a second inline valve coupled with the second fluid passage.

38. The method of claim 28 further comprising:
measuring at least one of flow rate or pressure differential of the agricultural fluid with at least one flow determining sensor.
